(19) United States
(12) Patent Application Publication
(10) Pub. No.: US 2011/0240551 A1
(43) Pub. Date: Oct. 6, 2011

(54) CRYSTALLINE POLYMER MICROPOROUS MEMBRANE, METHOD FOR PRODUCING THE SAME, AND FILTRATION FILTER USING THE SAME

(75) Inventors: Kenichi ISHIZUKA, Kanagawa (JP); Nobuhiro NISHITA, Kanagawa (JP)

(73) Assignee: FUJIFILM CORPORATION, Tokyo (JP)

(21) Appl. No.: 13/053,854

(22) Filed: Mar. 22, 2011

(30) Foreign Application Priority Data
Mar. 31, 2010 (JP) 2010-083830

(51) Int. Cl. B01D 29/46; B32B 5/22

(52) U.S. Cl. 210/490; 156/77

(57) ABSTRACT

A method for producing a crystalline polymer microporous membrane, which contains: placing a first crystalline polymer in a metal mold, and compressing the first crystalline polymer to form a first preforming body; placing a second crystalline polymer in a metal mold, and compressing the second crystalline polymer to form a second preforming body; extruding each of the first preforming body and the second preforming body to form a first extrusion body and a second extrusion body, respectively; laminating the first extrusion body and the second extrusion body to form a laminate; rolling the laminate; heating a surface of the laminate to perform asymmetric heating to thereby give a temperature gradient in a thickness direction of the laminate; and drawing the laminate.

### BACKGROUND OF THE INVENTION

1. Field of the Invention

The present invention relates to a crystalline polymer microporous membrane, a production method thereof, and a filtration filter using such crystalline polymer microporous membrane.

2. Description of the Related Art

Microporous membranes have been known for long and widely used for filtration filters, etc. As such microporous membranes, there are, for example, a microporous membrane using cellulose ester as a material thereof (see U.S. Pat. Nos. 1,421,341, 3,133,132, and 2,944,017, Japanese Patent Application Publication (JP-B) No. 48-40050), a microporous membrane using aliphatic polyamide as a material thereof (see U.S. Pat. Nos. 2,783,894, 3,408,315, 4,340,479, 4,340,480, and 4,450,126, German Patent No. 3,138,525, and Japanese Patent Application Laid-Open (JP-A) No. 58-37842), a microporous membrane using polyfluorocarbon as a material thereof (see U.S. Pat. Nos. 4,196,070, and 4,340,482, and JP-A Nos. 55-99934 and 58-91732), a microporous membrane using polypropylene as a material thereof (see West German Patent No. 3,003,400), and the like.

These microporous membranes are used for filtration and sterilization of washing water for use in the electronics industries, water for medical use, water for pharmaceutical production processes and water for use in the food industry. In recent years, the applications of and amount for using microporous membranes have increased, and microporous membranes have attracted great attention because of their high reliability in trapping particles. Among them, microporous membranes made of crystalline polymers are superior in chemical resistance, and in particular, microporous membranes produced by using polytetrafluoroethylene (PTEF) as a raw material are superior in both heat resistance and chemical resistance. Therefore, demands for such microporous membranes have been rapidly growing.

These microporous membranes are used for filtration and sterilization of washing water for use in the electronics industries, water for medical use, water for pharmaceutical production processes and water for use in the food industry. In recent years, the applications of and amount for using microporous membranes have increased, and microporous membranes have attracted great attention because of their high reliability in trapping particles. Among them, microporous membranes made of crystalline polymers are superior in chemical resistance, and in particular, microporous membranes produced by using polytetrafluoroethylene (may also referred to as “PTEF” hereinafter) as a raw material are superior in both heat resistance and chemical resistance. Therefore, demands for such microporous membranes have been rapidly growing.

For producing a porous PTFE membrane having a high void ratio as the aforementioned crystalline polymer microporous membrane, it has been proposed that the identical films which are separately prepared are compressed between compression rollers to thereby form into a layer (see JP-A No. 2009-501632). However, there is a problem in this proposal that the porous PTFE membrane prepared by such method cannot efficiently capture fine particles.

To solve this problem, it has been proposed physical properties (pore shapes) of the film is controlled, for example, by coating the PTFE membrane with a low-molecular weight PTFE dispersion liquid to thereby efficiently capture fine particles (see JP-A No. 11-35716). However, in this membrane, a thickness of each layer contained in the membrane is not controlled and thus it is difficult to satisfy all the required properties for the membrane, such as high flow rate, no clogging, long service life as a filter, and high durability, at the desirable balance.

Accordingly, there is currently strong demands for a crystalline polymer microporous membrane which is capable of efficiently capturing fine particles, has high filtration rate, does not cause clogging, has long service life, and has high durability, as well as a method for producing a crystalline polymer microporous membrane, which is capable of producing a crystalline polymer microporous membrane with a high degree of precision and a filtration filter using such crystalline polymer microporous membrane.

### BRIEF SUMMARY OF THE INVENTION

The present invention aims at providing a crystalline polymer microporous membrane which is capable of efficiently capturing fine particles, has high filtration rate, does not cause clogging, has long service life, and has high durability, as well as a method for producing a crystalline polymer microporous membrane, which is capable of producing a crystalline polymer microporous membrane with a high degree of precision and a filtration filter using such crystalline polymer microporous membrane.

Means for solving the aforementioned problems are as follows:

<1> A method for producing a crystalline polymer microporous membrane, containing:

placing a first crystalline polymer in a metal mold, and compressing the first crystalline polymer to form a first preforming body;

placing a second crystalline polymer in a metal mold, and compressing the second crystalline polymer to form a second preforming body;

extruding each of the first preforming body and the second preforming body to form a first extrusion body and a second extrusion body, respectively;

laminating the first extrusion body and the second extrusion body to form a laminate;

rolling the laminate;

heating a surface of the laminate to perform asymmetric heating to thereby give a temperature gradient in a thickness direction of the laminate; and drawing the laminate,

wherein the crystalline polymer microporous membrane contains a laminate of two or more layers, in which a layer containing the first crystalline polymer and a layer containing the second crystalline polymer are laminated, and a plurality of pores each piercing through the laminate in a thickness direction thereof,

wherein the first crystalline polymer has higher crystallinity than crystallinity of the second crystalline polymer, and the layer containing the first crystalline polymer has the maximum thickness thicker than the maximum thickness of the layer containing the second crystalline polymer, and

wherein at least one layer in the laminate has a plurality of pores whose average diameter continuously or discontinuously changes along with a thickness direction thereof at least at part of the layer.

<2> The method according to <1>, wherein the compressing is performed at a pressure of 0.01 MPa to 100 MPa.
<3> The method according to any of <1> or <2>, wherein the compressing is performed by applying a pressure for 0.01 seconds to 1,000 seconds.
<4> The method according to any one of <1> to <3>, wherein the compressing contains heating at 5° C. to 35° C.
<5> The method according to any one of <1> to <4>, wherein the extruding is performed at a temperature of 15° C. to 200° C.
<6> The method according to any one of <1> to <5>, wherein the extruding is performed at a pressure of 0.001 MPa to 1,000 MPa.
<7> The method according to any one of <1> to <6>, wherein the rolling is performed at a temperature of 19° C. to 380° C.
<8> The method according to any one of <1> to <7>, wherein the rolling is performed at a pressure of 0.001 MPa to 1,000 MPa.
<9> The method according to any one of <1> to <8>, wherein the asymmetric heating is performed at a temperature of 322° C. to 361° C.
<10> The method according to any one of <1> to <9>, wherein the laminate has a draw ratio of 1.2 times to 50 times with respect to a length direction of the laminate.
<11> The method according to any one of <1> to <10>, wherein the laminate has a draw ratio of 1.2 times to 50 times with respect to a width direction of the laminate.
<12> The method according to any one of <1> to <11>, wherein the first extrusion body has a thickness thicker than that of the second extrusion body.
<13> The method according to any one of <1> to <12>, wherein the first crystalline polymer has the crystallinity 1.02 or more times the crystallinity of the second crystalline polymer.
<14> The method according to any one of <1> to <13>, wherein the first crystalline polymer is polytetrafluoroethylene.
<15> The method according to any one of <1> to <14>, wherein the second crystalline polymer is polytetrafluoroethylene, or a polytetrafluoroethylene copolymer.
<16> A crystalline polymer microporous membrane, obtained by the method as defined in any one of <1> to <15>.
<17> A filtration filter, containing:

the crystalline polymer microporous membrane as defined in <16>.

<18> The filtration filter according to <17>, wherein a surface of the crystalline polymer microporous membrane having an average pore diameter larger than the other surface thereof is arranged as a filtering surface of the filtration filter.

### BRIEF DESCRIPTION OF THE DRAWINGS

FIG. 1 is a schematic diagram showing one example of the crystalline polymer microporous membrane of the two-layer structure of the present invention.

FIG. 2 is a schematic diagram showing one example of the conventional crystalline polymer microporous membrane of the two-layer structure.

FIG. 3 is a schematic diagram showing one example of the crystalline polymer microporous membrane of the three-layer structure of the present invention (part 1).

FIG. 4 is a schematic diagram showing one example of the conventional crystalline polymer microporous membrane of the three-layer structure.

FIG. 5 is a diagram showing the process of the method for producing a crystalline polymer microporous membrane of the present invention.

FIG. 6 is a diagram showing one example of a preforming body.

FIG. 7 is a diagram showing another process of the method for producing a crystalline polymer microporous membrane of the present invention.

FIG. 8 is a diagram showing a common structure of a pleated filter element before mounted in a housing.

FIG. 9 is a diagram showing a common structure of a filter element before mounted in a housing of a capsule filter cartridge.

FIG. 10 is a diagram showing a common structure of a capsule filter cartridge integrated with a housing.

FIG. 11 is a schematic diagram showing one example of the crystalline polymer microporous membrane of the three-layer structure of the present invention (part 2).

FIG. 12 is a schematic diagram showing one example of the crystalline polymer microporous membrane of the three-layer structure of the present invention (part 3).

FIG. 13 is a schematic diagram showing one example of the crystalline polymer microporous membrane of the four-layer structure of the present invention.

FIG. 14 is a schematic diagram showing one example of the crystalline polymer microporous membrane of the five-layer structure of the present invention.

### DETAILED DESCRIPTION OF THE INVENTION

### (Crystalline Polymer Microporous Membrane)

The crystalline polymer microporous membrane of the present invention contains at least a laminate, and may further contain other structures, if necessary.

### <Laminate>

The laminate contains at least a layer containing a first crystalline polymer (may also referred to as “high crystalline polymer” hereinafter) and a layer containing a second crystalline polymer (may also referred to as “low crystalline polymer” hereinafter), and may further contain other layers, if necessary.

The laminate means “a multilayer structure” formed by stacking two or more crystalline polymer layers, not “a single-layer structure.”

The aforementioned “laminate structure” can be clearly distinguished from the “single-layer structure”, which has no border in the structure, by the fact that the laminate structure has a border between a crystalline polymer layer and another crystalline polymer layer. Here, the presence of the border between a crystalline polymer layer and another crystalline polymer can be detected for example by observing a cross-section of the crystalline polymer microporous membrane cut in the direction along with a thickness through an optical microscope or a scanning electron microscope (SEM).

The structure of the laminate is suitably selected depending on the intended purpose without any restriction, provided that the structure contains two or more layers. The structure of the laminate is preferably a structure thereof containing two or more layers each containing the first crystalline polymer (i.e., high crystalline polymer) and one layer containing the second crystalline polymer (i.e., low crystalline polymer), more preferably a three-layer structure containing two layers each containing the first crystalline polymer (i.e., high crystalline polymer), and one layer containing the second crystalline polymer (i.e., low crystalline polymer) provided between the two layers each containing the first crystalline polymer (i.e., high crystalline polymer).

By giving the three-layer structure to the crystalline polymer microporous membrane, as well as preventing the membrane from curling caused by the difference in the shrinkage rate between layers, the capturing performance of the membrane can be stabilized by preventing the second crystalline polymer (i.e. the low crystalline polymer layer) having the smallest pore diameter, which gives the largest influence to a diameter of particles to be captured, from factors of physical damages such as frictions and scratches.

Moreover, in the three-layer structure, it is preferred that a thickness of one of the layers each containing the first crystalline polymer (i.e., high crystalline polymer) be thicker than a thickness of the layer containing the second crystalline polymer (i.e., low crystalline polymer), and the other layer containing the first crystalline polymer (i.e., high crystalline polymer) is thicker than the thickness of the layer containing the second crystalline polymer (i.e., low crystalline polymer). By arranging the crystalline polymer microporous membrane so that the layer having the first crystalline polymer (i.e., high crystalline polymer) thicker than that of the layer containing the second crystalline polymer (i.e., low crystalline polymer) faces the side of an outlet, a flow rate of the crystalline polymer microporous membrane can be improved.

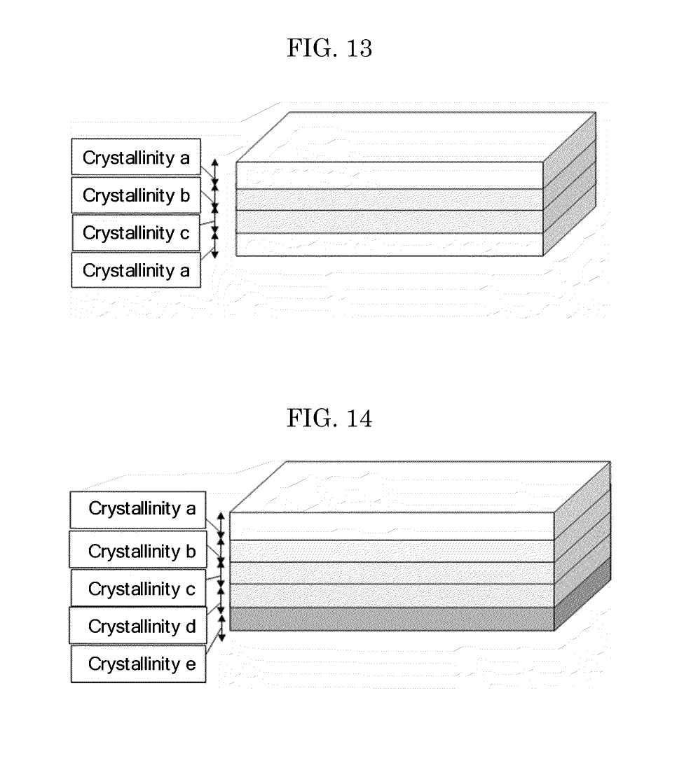

Examples of the structure of the laminate include: a four-layer laminate structure (FIG. 13) in which the crystalline polymer layers having three different crystallinities (molecular weights), i.e. crystallinity a, b, and c, are included; and a five-layer laminate structure (FIG. 14) in which the crystalline polymer layers having five different crystallinities (molecular weights), i.e. crystallinity a, b, c, d, and e, are included. Here, it is preferred that the crystalline polymer layer closer to the side of the outlet (side of the outlet for filtrate) have the lower crystallinity (molecular weight) of the crystalline polymer forming the crystalline polymer.

In the crystalline polymer microporous membrane of the present invention, a plurality of pores piercing through the laminate are formed in the thickness direction of the laminate, and at least one of the layers constituting the laminate has a plurality of pores whose average diameter is continuously or discontinuously changed at least part of the laminate in the thickness direction thereof. According to such configuration, the crystalline polymer microporous membrane can efficiently capture fine particles without causing clogging, and give long service life.

The fact “a plurality of pores piercing through the laminate are formed” can be confirmed by observing under an optical microscope or a scanning electron microscope (SEM).

The change of the average pore diameter along with the thickness direction is either continuous or discontinuous increase, or continuous or discontinuous decrease.

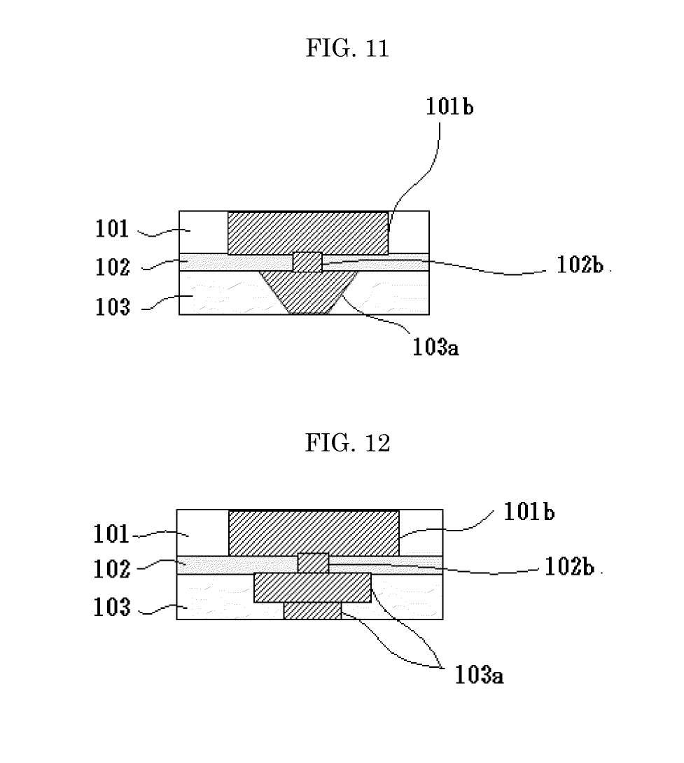

The aforementioned phrase “at least one of the layers constituting the laminate has a plurality of pores whose average diameter is continuously or discontinuously changed at least part of the laminate in the thickness direction thereof” means that when the distance (d) from the from surface of the crystalline polymer microporous membrane in the thickness direction (which is equivalent to the depth from the front surface) is plotted on the horizontal axis on a graph, and the average pore diameter (D) is plotted on the vertical axis on the graph, (1) the graph covering from the front surface (d=0) to the back surface (d=film thickness) is represented by one continuous line (continuous change) per crystalline polymer layer, and the inclination (dD/dt) of the graph is in the region of negative (decreasing) or positive (increasing), and (2) the graph covering from the front surface (d=0) to the back surface (d=film thickness) is represented by one continuous or discontinuous line per crystalline polymer layer. Namely, it contains embodiments illustrated in FIGS. 11 and 12. Here, the region where the inclination is 0 (zero) (no change) may be included in part or entirely, but it is preferred that the graph include a complete inclination without containing the region where the inclination is 0 (zero) (no change).

Among the aforementioned embodiments, the particularly preferable embodiment is such that the graph representing the average diameter of pores in at least one layer of the laminate from the front surface to the back surface be continuously decreased.

In the present specification, the plane of the crystalline polymer microporous membrane on which the average diameter of the pores is larger than the other plane, which is present the opposite side to the side to be subjected to asymmetric heating, is referred to as “a front surface,” and the other plane on which the average diameter of the pore is smaller, which is the side to be subjected to asymmetric heating, is referred to as “a back surface”. However, these are merely names applied for convenience to explaining the present invention in a simple manner. Therefore, either plane of the unbaked laminated polytetrafluoroethylene film (laminate) can be subjected to asymmetric heating to be “the back surface.”

In the crystalline polymer microporous membrane, the ratio of the average diameter of the pores on the front surface to that on the back surface (the average pore diameter of the front surface/the average pore diameter of the back surface) is suitably selected depending on the intended purpose without any restriction, but it is preferably 1.2 times to 2.0×10⁴ times, more preferably 1.5 times to 1.0×10⁴ times, and even more preferably 2.0 times to 2.0×10³ times.

The average diameter of the pores on the front surface of the crystalline polymer microporous membrane is suitably selected depending on the intended purpose without any restriction, but it is preferably 0.1 μm to 500 μm, more preferably 0.25 μm to 250 μm, and even more preferably 0.50 μm to 100 μm.

When the average diameter thereof is less than 0.1 μm, the flow rate of the resulting membrane may decrease. When the average diameter thereof is more than 500 μm, the resulting membrane may not efficiently capture fine particles. By contrast, when the average diameter thereof is within the aforementioned even more preferable range, it is advantageous because the resulting membrane achieve both the desirable flow rate and fine particle capturing ability.

The average pore diameter of the pores present on the back surface of the crystalline polymer microporous membrane is suitably selected depending on the intended purpose without any restriction, but it is preferably 0.01 μm to 5.0 μm, more preferably 0.025 μm to 2.5 μm, and even more preferably 0.05 μm to 1.0 μm.

When the average pore diameter is smaller than 0.01 μm, the flow rate of the resulting crystalline polymer microporous membrane may be low. When the average pore diameter is larger than 5.0 μm, the resulting crystalline polymer microporous membrane may not be able to efficiently capture fine particles. When the average pore diameter is within the aforementioned even more preferable range, it is advantageous in light of the flow rate and the fine particle capturing performance.

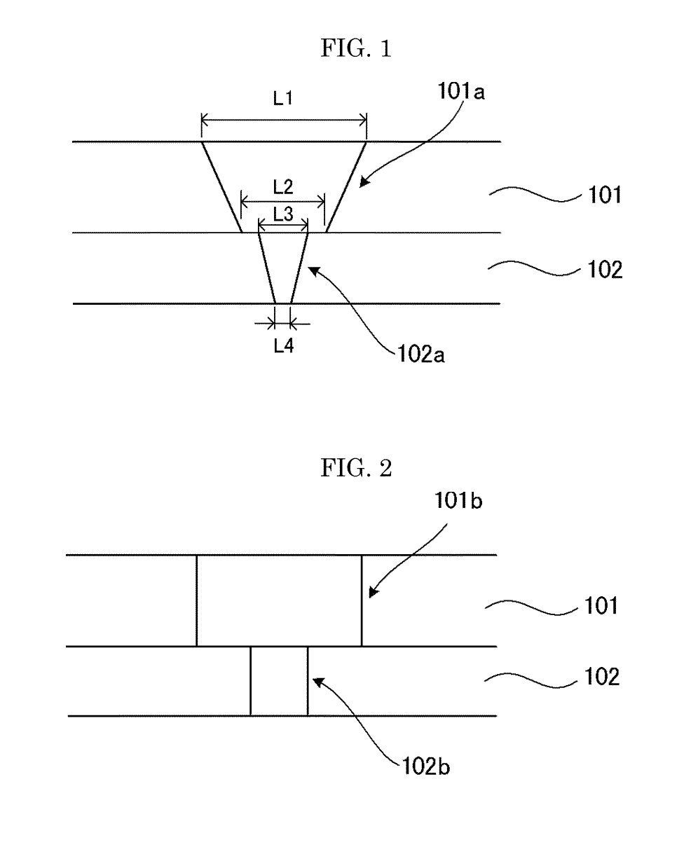

As shown in FIG. 1, the diameters of the pores 101a, 102a in the crystalline polymer microporous membrane of the present invention having a two-layer structure laminating two crystalline polymer layers 101, 102 all change (continuously decrease) along with the thickness direction of the laminate. Looking at the crystalline polymer microporous membrane as a whole, the pore diameters change (decrease stepwise) in the thickness direction thereof.

Comparing to this, as shown in FIG. 2, all the diameters of the pores 101b, 102b in the conventional crystalline polymer microporous membrane having a two-layer structure laminating two crystalline polymer layers 101, 102 do not change in the thickness direction of the laminate, and the pore diameters change (decrease stepwise) in the thickness direction of the crystalline polymer microporous membrane, as a whole.

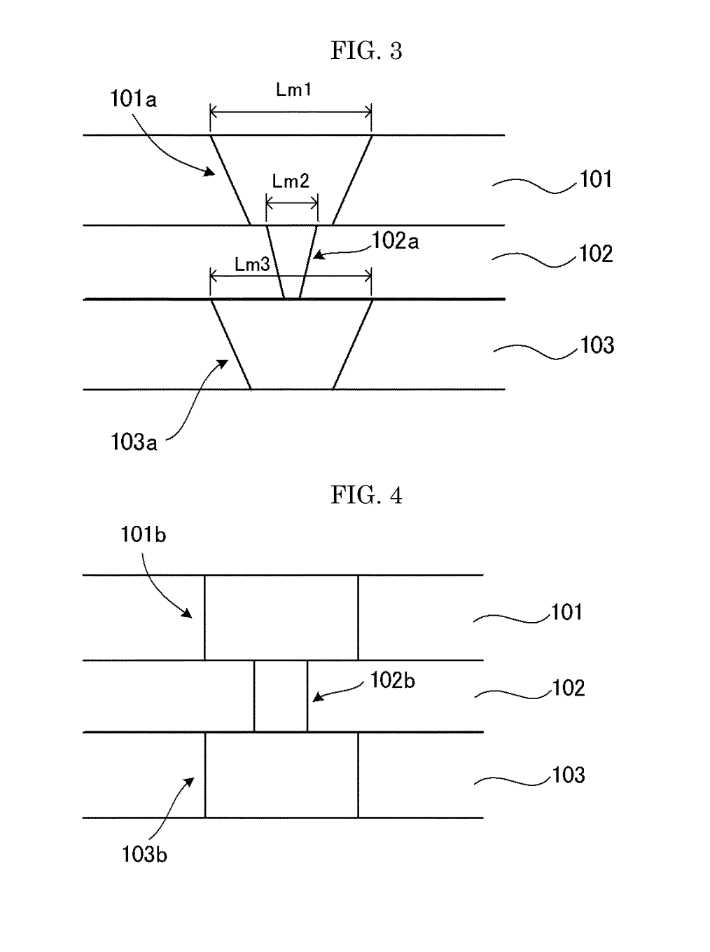

Moreover, as shown in FIG. 3, the diameters of the pores 101a, 102a, 103a of the crystalline polymer microporous membrane of the present invention having a three-layer structure in which crystalline polymer layers 101, 102, 103 are laminated all changed (continuously decrease) along with the thickness direction of the laminate. Looking at the crystalline polymer microporous membrane as a whole, the pore diameters change (decrease stepwise) in the thickness direction thereof.

To compare with this, as shown in FIG. 4, all of the diameters of pores 101b, 102b, 103b of the crystalline polymer microporous membrane of the conventional three-layer structure in which three crystalline polymer layers 101, 102, 103 are laminated do not change in the thickness direction of the laminate, and as a whole, there are portions where the diameters of the pores change stepwise along with the thickness direction of the laminate.

Moreover, the crystalline polymer layers in the crystalline polymer microporous membrane each preferably have different pore opening diameters at the ends. Specifically, as shown in FIG. 1, in the case where the diameters of the pores 101a, 102a of each crystalline polymer layer 101, 102 continuously or discontinuously reduces along with the thickness direction of the laminate, the opening diameters L1, L2 of the both ends have a relationship of L1>L2, the opening diameters L3, L4 of the both ends have a relationship of L3>L4.

In this case, in each crystalline polymer layer, the ratio of the average pore diameter of the front surface to that of the back surface (the average pore diameter of the front surface/the average pore diameter of the back surface) is suitably selected depending on the intended purpose without any restriction, but it is preferably 1.1 times to 30 times, more preferably 1.25 times to 25 times, and even more preferably 1.5 times to 20 times.

The average diameter of the pores present in the front surface of each crystalline polymer layer is suitably selected depending on the intended purpose without any restriction, but it is preferably 0.001 μm to 500 μm, more preferably 0.002 μm to 250 μm, and even more preferably 0.005 μm to 100 μm.

The average diameter of the pores present in the back surface of each crystalline polymer is suitably selected depending on the intended purpose without any restriction, but it is preferably 0.001 μm to 500 μm, more preferably 0.002 μm to 250 μm, and even more preferably 0.003 μm to 100 μm.

Moreover, it is preferred that the crystalline polymer having the maximum average pore diameter be present at the inner portion of the laminate in which the three or more crystalline polymer layers are laminated. By arranging the laminate in such manner, the crystalline polymer having the minimum average pore diameter, which largely influences to the diameter of particles to be captured, can be protected from physical damages such as abrasion or scratching, and hence the particle capturing performance of the resulting crystalline polymer microporous membrane can be stabilized.

As shown in FIG. 3, in the case where the three-layer structure crystalline polymer microporous membrane in which the crystalline polymer layers 101, 102, 103 are laminated has pores 101a, 102a, 103a whose maximum average pore diameters are respectively Lm1, Lm2, Lm3, the crystalline polymer layer 102 having the smallest maximum average pore diameter Lm2 among the maximum average pore diameter Lm1, Lm2, Lm3 is present at the inner portion of the crystalline polymer microporous membrane (i.e. the laminate).

The average pore diameter is, for example, measured in the following manner. A surface of the membrane is photographed (SEM photograph with a magnification of ×1,000 to ×50,000) using a scanning electron microscope (HITACHI S-4300, 4700 type, manufactured by Hitachi, Ltd.), and an image of the obtained photograph is taken into an image processing apparatus (Name of main body: TV IMAGE PROCESSOR TVIP-4100II, manufactured by Nippon Avionics Co., Ltd., Name of control software: TV IMAGE PROCESSOR IMAGE COMMAND 4198, manufactured by Ratoc System Engineering Co., Ltd.) so as to extract an image only containing crystalline polymer fibers. Based on this image of the crystalline polymer fibers, the average pore diameter is calculated by arithmetically processing the measured pores on the image.

The most frequent pore diameter is suitably selected depending on the intended purpose without any restriction, but it is preferably 0.001 μm to 0.5 μm.

When the most frequent pore diameter is less than 0.001 μm, the resulting membrane may not have a sufficient flow rate. When the most frequent pore diameter is more than 0.5 μm, the resulting membrane may have an impaired capturing rate for particles of a small diameter.

The most frequent pore diameter can be measured by Perm Porometer manufactured by Porous Materials, Inc.

### —Crystalline Polymer—

In the present specification, the term “crystalline polymer” means a polymer having a molecular structure in which crystalline regions containing regularly-aligned long-chain molecules are mixed with amorphous regions having not regularly aligned long-chain molecules. Such polymer exhibits crystallinity through a physical treatment. For example, if a polyethylene film is drawn by an external force, a phenomenon is observed in which the initially transparent film turns to the clouded film in white. This phenomenon is derived from the expression of crystallinity which is obtained when the molecular alignment in the polymer is aligned in one direction by the external force.

The crystalline polymer is suitably selected depending on the intended purpose without any restriction, and examples thereof include polyalkylene, polyester, polyamide, polyether, and liquid crystalline polymer. Specific examples of the crystalline polymer include polyethylene, polypropylene, nylon, polyacetal, polybutylene terephthalate, polyethylene terephthalate, syndiotactic polystyrene, polyphenylene sulfide, polyether ether ketone, wholly aromatic polyamide, wholly aromatic polyester, fluororesin, and polyether nitrile.

Among them, polyalkylene (e.g. polyethylene and polypropylene) is preferable, fluoropolyalkylene in which a hydrogen atom of the alkylene group in polyalkylene is partially or wholly substituted with a fluorine atom is more preferable, and polytetrafluoroethylene (PTFE) is particularly preferable, as they have desirable chemical resistance and handling properties.

The polyethylene varies in its density depending on the branching degree thereof and generally classified into low-density polyethylene (LDPE) that has a high branching degree and low crystallinity, and high-density polyethylene (HDPE) that has a low branching degree and high crystallinity. Both LDPE and HDPE can be used in the present invention. Among them, HDPE is particularly preferable in light of the easiness of the crystallinity control.

As the aforementioned polytetrafluoroethylene, polytetrafluoroethylene prepared by emulsification polymerization can be generally used, and use of powdery polytetrafluoroethylene obtained by the coagulation of the aqueous dispersion liquid obtained by the emulsification polymerization is preferable.

The polytetrafluoroethylene is suitably selected depending on the intended purpose without any restriction. For example, commercially available products of polytetrafluoroethylene can be used. Examples of such commercial products include: POLYFLON PTFE F-104, POLYFLON PTFE F-106, POLYFLON PTFE F-201, POLYFLON PTFE F-205, POLYFLON PTFE F-207, and POLYFLON PTFE F-301 (all manufactured by DAIKIN INDUSTRIES, LTD.); FLUON PTFE CD1, FLUON PTFE CD141, FLUON PTFE CD145, FLUON PTFE CD123, FLUON PTFE CD076, and FLUON PTFE CD090 (all manufactured by ASAHI GLASS CO., LTD.); and Teflon® PTFE 6-J, Teflon® PTFE 62XT, Teflon® PTFE 6C-J, and Teflon® PTFE 640-J (all manufactured by DU PONT-MITSUI FLUOROCHEMICALS COMPANY, LTD.). Among them, F-104, F-106, F-205, CD1, CD141, CD145, CD123, and 6-J are preferable, F-104, F-106, F-205, CD1, CD123, and 6-J are more preferable, and F-106 and F-205 are even more preferable.

The glass-transition temperature of the crystalline polymer is suitably selected depending on the intended purpose without any restriction, but it is preferably 40° C. to 400° C., more preferably 50° C. to 350° C.

The mass average molecular weight of the crystalline polymer is suitably selected depending on the intended purpose without any restriction, but it is preferably in the range of 1,000 to 100,000,000.

The number average molecular weight of each crystalline polymer is suitably selected depending on the intended purpose without any restriction, but it is preferably 500 to 50,000,000, more preferably 1,000 to 10,000,000.

The number average molecular weight can be measured, for example, by gel permeation chromatography (GPC). Since PTFE is insoluble to a solvent, however, it is preferred that the number average molecular weight thereof be measured by measuring heat of crystallization [ΔHc (cal/g)] and calculating using the measured value in the relational expression: Mn=2.1×10¹⁰×ΔHc^{-5.16}.

The total thickness of the crystalline polymer microporous membrane is suitably selected depending on the intended purpose without any restriction, but it is preferably 1 μm to 300 μm, more preferably 5 μm to 200 μm, and even more preferably 10 μm to 100 μm.

The maximum thickness of the layer containing the first crystalline polymer (i.e., high crystalline polymer) is suitably selected depending on the intended purpose without any restriction, provided that it is thicker than the maximum thickness of the layer containing the second crystalline polymer (i.e., low crystalline polymer), but it is preferably 1.2 times or more, more preferably 1.25 times or more, and even more preferably 1.5 times or more thicker than the maximum thickness of the layer containing the second crystalline polymer (i.e., low crystalline polymer).

When the maximum thickness of the layer containing the high crystalline polymer is less than 1.2 times the maximum thickness of the layer containing the low crystalline polymer, the low crystalline polymer layer tends to receive influences from frictions and scratches, and thus the fine particle capturing performance of the resulting membrane may not be stably maintained. When the maximum thickness of the layer containing the high crystalline polymer is within the even more preferable range, it is advantageous in light of the fine particle capturing performance.

Note that in the case where an intermediate layer containing both a high crystalline polymer and a low crystalline polymer is present at an interface of each layer, the intermediate layer is not classified as neither of the layer containing the first crystalline polymer (i.e., high crystalline polymer) nor the layer containing the second crystalline polymer (i.e., crystalline polymer).

### <<Layer Containing First Crystalline Polymer (High Crystalline Polymer)>>

The layer containing the first crystalline polymer (i.e., high crystalline polymer) is suitably selected depending on the intended purpose without any restriction, provided that it contains the first crystalline polymer (i.e., high crystalline polymer).

The maximum thickness of the layer containing the first crystalline polymer (i.e., crystalline polymer) is thicker than the maximum thickness of the layer containing the second crystalline polymer (i.e., low crystalline polymer). By adjusting the thicknesses of the layers in this manner, the flow rate of the crystalline polymer microporous membrane can be improved.

Here, “the maximum thickness” means the largest value of the thickness among thicknesses of all the layers. For example, in the case where the laminate includes the 20 μm-thick layer containing the first crystalline polymer (i.e., high crystalline polymer), the 15 μm-thick layer containing the first crystalline polymer (i.e., high crystalline polymer), and the 10 μm-thick layer containing the first crystalline polymer (high crystalline polymer), the maximum thickness of the layer containing the first crystalline polymer (i.e., high crystalline polymer) is 20 μm. In the case where the laminate includes the 20 μm-thick layer containing the second crystalline polymer (i.e., low crystalline polymer), the 15 μm-thick second crystalline polymer (i.e., low crystalline polymer), and the 10 μm-thick second crystalline polymer (i.e., low crystalline polymer), the maximum thickness of the second crystalline polymer (i.e., low crystalline polymer) is 20 μm.

The thickness of the layer containing the first crystalline polymer (i.e., high crystalline polymer) is suitably selected depending on the intended purpose without any restriction, but it is preferably 1.0 μm to 100 μm, more preferably 1.25 μm to 75 μm, and even more preferably 1.5 μm to 50 μm.

When the thickness of the layer containing the first crystalline polymer (i.e., high crystalline polymer) is less than 1.0 μm, the low crystalline polymer layer tends to receive influences from frictions and scratches, and thus the fine particle capturing performance of the resulting membrane may not be stably maintained. When the thickness of the layer containing the first crystalline polymer is more than 100 μm, the resulting membrane may not have a sufficient flow rate. When the thickness of the layer containing first crystalline polymer (i.e., high crystalline polymer) is within the aforementioned even more preferable range, it is advantageous in light of the fine particle capturing performance and flow rate.

In the case where the crystalline polymer microporous membrane has a two-layer structure, the ratio of the thickness of the layer containing the first crystalline polymer (i.e., high crystalline polymer) to the thickness of the layer containing the second crystalline polymer (i.e., low crystalline polymer) is preferably 10,000/1 to 1.2/1, more preferably 5,000/1 to 1.25/1, and even more preferably 1,000/1 to 1.5/1.

When the ratio is more than 10,000/1, the thickness of the low crystalline polymer layer may not be controlled with precision. When the ratio is less than 1.2/1, the low crystalline polymer layer tends to receive influences from frictions and scratches, and thus the fine particle capturing performance of the resulting membrane may not be stably maintained. When the ratio is within the aforementioned even more preferable range, it is advantageous in view of the film thickness control and fine particle capturing performance.

In the case where the crystalline polymer microporous membrane has a three-layer structure where one layer of the second crystalline polymer (i.e., low crystalline polymer) is provided between two layers each containing the first crystalline polymer (i.e., high crystalline polymer), the ratio of the maximum thickness of the layer containing the first crystalline polymer (i.e., high crystalline polymer) to the layer containing the second crystalline polymer (i.e., low crystalline polymer) is preferably 5,000/1 to 1.2/1, more preferably 2,500/1 to 1.25/1, and even more preferably 1,000/1 to 1.5/1.

When this ratio is more than 5,000/1, there may be a possibility that the thickness of the layer containing the low crystalline polymer cannot be accurately controlled. When the ratio is less than 1.2/1, the layer containing the low crystalline polymer suffers from frictions or scratches, and thus the resulting membrane may not be able to stably maintain its capturing ability of fine particles. When the ratio is within the aforementioned even more preferable range, it is advantageous because the desirable film thickness control and capturing ability of fine particles can be attained.

The thickness of the other layer (i.e. the layer other than the layer having the maximum thickness) within the two layers each containing the first crystalline polymer (i.e., high crystalline polymer) is suitably selected depending on the intended purpose without any restriction, but it is preferably thinner than the layer containing the second crystalline polymer, more preferably 0.5 or less times the thickness of the layer containing the second crystalline polymer.

When the thickness thereof is thicker than the thickness of the layer containing the second crystalline polymer, the flow rate of the resulting membrane may not be sufficient. When the thickness thereof is within the aforementioned preferable range, it is advantageous because the desirable flow rate can be attained.

Here, a thickness of each layer can be measured for example by freezing and fracturing the microporous membrane and observing the cross-section thereof under a scanning electron microscope (SEM).

### —First Crystalline Polymer (i.e., High Crystalline Polymer)—

The first crystalline polymer (i.e., high crystalline polymer) is suitably selected depending on the intended purpose without any restriction, provided that it is a crystalline polymer having the higher degree of crystallinity than that of the low crystalline polymer described later. The first crystalline polymer is preferably polytetrafluoroethylene (PTFE) because of its desirable chemical resistance.

The crystallinity of the first crystalline polymer (i.e., high crystalline polymer) is suitably selected depending on the intended purpose without any restriction, provided that it is higher than the crystallinity of the second crystalline polymer (i.e., low crystalline polymer) described later, but it is preferably 1.02 or more times, more preferably 1.03 or more times, and even more preferably 1.05 or more times the crystallinity of the second crystalline polymer (i.e., low crystalline polymer).

When the degree of crystallinity of the first crystalline polymer (i.e., high crystalline polymer) is less than 1.02 times the crystallinity of the second crystalline polymer (i.e., low crystalline polymer), the pore diameters in the high crystalline polymer layer and those in the low crystalline polymer layer become similar, and thus fine particles may not be efficiently captured by the resulting membrane. When the crystallinity of the first crystalline polymer (i.e., high crystalline polymer) is within the aforementioned even more preferable range, it is advantageous in view of the fine particle capturing performance.

Note that, the “crystallinity” can be determined by the following formula:

$$\frac{1}{ρ} = \frac{C}{{ρ}_{c}} + \frac{1 - C}{{ρ}_{a}}$$

In the formula above, 100C denotes crystallinity (%), ρ denotes a density of a sample, ρₐ denotes a density of a perfect crystal (in the case of PTFE, 2.302), and ρ_{c} denotes a density of amorphous (in the case of PTFE, 2.060). The density of the sample can be measured by a dry-type or wet-type densitometer, density gradient tube, or the like, such as ACCUPYC II 1340, and ACCUPYC 1330, both manufactured by Shimadzu Corporation.

Moreover, the degree of crystallinity can be measured, for example, by wide angle X-ray diffraction, NMR, infrared (IR) spectroscopy, DSC, or the method described in page 45 of “Fluororesin Handbook” (edited by Takaomi Satokawa, published by Nikkan Kogyo Shinbun, Ltd.).

### <<Layer Containing Second Crystalline Polymer (i.e., Low Crystalline Polymer)>>

The layer containing the second crystalline polymer (i.e., low crystalline polymer) is suitably selected depending on the intended purpose without any restriction, provided that it contains the second crystalline polymer (i.e., low crystalline polymer).

The maximum thickness of the layer containing the second crystalline polymer (i.e., low crystalline polymer) is thinner than the maximum thickness of the layer containing the first crystalline polymer (i.e., high crystalline polymer). By adjusting the thicknesses of the layers in this manner, the flow rate of the resulting crystalline polymer microporous membrane can be improved.

The thickness of the layer containing the second crystalline polymer (i.e., low crystalline polymer) is suitably selected depending on the intended purpose without any restriction, but it is preferably 0.01 μm to 100 μm, more preferably 0.02 μm to 80 μm, and even more preferably 0.03 μm to 60 μm.

When the thickness of the layer containing the second crystalline polymer (i.e., low crystalline polymer) is less than 0.01 μm, uniformity of the pore diameters may be disturbed within the plane. When the thickness thereof is more than 100 nm, the resulting membrane may not have a high flow rate. When the thickness of the layer containing the second crystalline polymer (i.e., low crystalline polymer) is within the aforementioned even more preferable range, it is advantageous in view of the obtainable uniformity of pore size on the entire surface and flow rate.

### —Second Crystalline Polymer (i.e., Low Crystalline Polymer)—

The second crystalline polymer (i.e., low crystalline polymer) is suitably selected depending on the intended purpose without any restriction, provided that it is a crystalline polymer having the degree of crystallinity lower than that of the first crystalline polymer (i.e., high crystalline polymer), but it is preferably polytetrafluoroethylene (PTFE), or a polytetrafluoroethylene copolymer, in view of its desirable chemical resistance.

The polytetrafluoroethylene copolymer is suitably selected depending on the intended purpose without any restriction. Examples thereof include a tetrafluoroethylene-perfluoroalkylvinyl ether copolymer, a tetrafluoroethylene-hexafluoropropylene copolymer, and a tetrafluoroethylene-ethylene copolymer.

### (Method for Producing Crystalline Polymer Microporous Membrane)

The method for producing a crystalline polymer microporous membrane of the present invention contains at least a laminate forming step, an asymmetric heating step, a drawing step, and a heat setting step, and may further contain other steps, if necessary.

### <Laminate Forming Step>

The laminate forming step includes: placing a first crystalline polymer in a metal mold, and compressing the first crystalline polymer to form a first preforming body; placing a second crystalline polymer in a metal mold, and compressing the second crystalline polymer to form a second preforming body; extruding each of the first preforming body and the second preforming body to respectively form a first extrusion body and a second extrusion body; laminating the first extrusion body and the second extrusion body to form a laminate; and rolling the laminate, and may further include heating during the compressing, cooling during the compressing, or the like, if necessary.

### <<Formation of Preforming Body>>

The first and second crystalline polymers (high crystalline polymer and low crystalline polymer) are suitably selected from those mentioned above depending on the intended purpose.

The metal mold is suitably selected depending on the intended purpose without any restriction. For example, a metal mold known in the art can be used here.

The composition to be placed in the metal mold is suitably selected depending on the intended purpose without any restriction, provided that it contains the first crystalline polymer or the second crystalline polymer, and it is preferred that the composition further contain an extrusion aid and the like.

As the extrusion aid, a fluid lubricant is preferably used, and examples of such fluid lubricant include solvent naptha, liquid paraffin, and the like. Moreover, as the extrusion aid, commercial products can be used. For example, hydrocarbon oil such as ISOPAR, manufactured by Esso Sekiyu K.K. may be used the commercial product of the extrusion aid. The amount of the extrusion aid for use is preferably 15 parts by mass to 30 parts by mass relative to 100 parts by mass of the crystalline polymer.

The form of the composition to be placed in the metal mold is suitably selected depending on the intended purpose without any restriction, but it is preferably a paste.

The pressure during the compression is suitably selected depending on the intended purpose without any restriction, but it is preferably 0.01 MPa to 100 MPa, more preferably 0.025 MPa to 75 MPa, and even more preferably 0.05 MPa to 50 MPa.

When the pressure is less than 0.01 MPa, the paste may not be sufficiently set, and thus a preforming body may not be formed. When the pressure is more than 100 MPa, the extrusion aid may oozed out, which loose the flow ability of the paste, and thus extrusion may not be performed in the following step. On the other hand, the pressure in the aforementioned even more preferable range is advantageous because the resulting preformed body can allow the formation of a flowable paste with excellent preferable reproducibility in the extrusion step.

The duration for applying the pressure for the compression is suitably selected depending on the intended purpose without any restriction, but it is preferably 0.01 seconds to 1,000 seconds, more preferably 0.05 seconds to 500 seconds, and even more preferably 0.1 seconds to 100 seconds.

When the duration for applying the pressure is shorter than 0.01 seconds, the paste may not be sufficiently set, and thus a preforming body may not be formed. When the duration is longer than 1,000 seconds, the extrusion aid may oozed out, which loose the flow ability of the paste, and thus extrusion may not be performed in the following step. On the other hand, the duration in the aforementioned even more preferable range is advantageous because the resulting preformed body can allow the formation of a flowable paste with excellent preferable reproducibility in the extrusion step.

The reaching temperature during the compression is suitably selected depending on the intended purpose without any restriction, but it is preferably 5° C. to 35° C., more preferably 10° C. to 33° C., and even more preferably 19° C. to 30° C.

When the temperature is lower than 5° C., the extrusion aid may oozed out, which loose the flow ability of the paste, and thus extrusion may not be performed in the following step. When the temperature is higher than 35° C., the paste may not be sufficiently set, and thus a preforming body may not be formed. On the other hand, the maximum temperature in the aforementioned even more preferable range is advantageous because the resulting preformed body can allow the formation of a flowable paste with excellent preferable reproducibility in the extrusion step.

### <<Formation of Extrusion Body>>

The formation of the extrusion body can be performed in accordance with an extrusion method of a paste known in the art, without any restriction.

At first, the first preforming body is extruded and shaped to form a first extrusion body, and then the second preforming body is extruded and shaped to form a second extrusion body.

The extrusion can be performed, for example, by a paste extruder known in the art.

The temperature during the extrusion is preferably 15° C. to 200° C., more preferably 17° C. to 150° C., and even more preferably 19° C. to 100° C.

When the temperature is lower than 15° C., the sufficient flow ability of the preformed body cannot be obtained, and thus the extrusion may not be performed thereon. When the temperature is higher than 200° C., the extrusion aid may be evaporated. On the other hand, the temperature in the aforementioned even more preferable range is advantageous because the preforming body can be extruded to stably provide an extrusion body.

The pressure during the extrusion is suitably selected depending on the intended purpose without any restriction, but it is preferably 0.001 MPa to 1,000 MPa, more preferably 0.005 MPa to 500 MPa, and even more preferably 0.01 MPa to 100 MPa.

When the pressure is lower than 0.001 MPa, the sufficient flow ability of the preformed body cannot be obtained, and thus the extrusion may not be performed thereon. When the pressure is higher than 1,000 MPa, shearing stress may not be sufficiently provided to the preforming body and thus the resulting extrusion body may not have desirable morphological stability. On the other hand, the pressure in the aforementioned even more preferable range is advantageous because the preforming body can be extruded to provide an extrusion body having excellent morphological stability.

Note that, it is preferred that the temperature and pressure during the extrusion be controlled to give the second extrusion body its thickness thinner than the thickness of the first extrusion body.

The shape of the extrusion body is suitably selected depending on the intended purpose without any restriction. The shape of the extrusion body is generally preferably a rod shape or a sheet shape.

### <<Laminate>>

The first extrusion body and the second extrusion body are laminated to form a laminate of at least two layers.

### <<Rolling>>

The rolling is suitably selected depending on the intended purpose without any restriction. For example, the rolling can be performed by calendering at the speed of 5 m/min using a calender roller.

The pressure applied during the rolling is suitably selected depending on the intended purpose without any restriction, but it is preferably 0.001 MPa to 1,000 MPa, more preferably 0.002 MPa to 600 MPa, and even more preferably 0.035 MPa to 350 MPa.

When the pressure is lower than 0.001 MPa, the shearing stress cannot be sufficiently provided and thus the rolling may not be performed properly. When the pressure is higher than 1,000 MPa, the membrane is rolled out excessively thin and thus the sufficient strength of the membrane may not be obtained. When the pressure is within the aforementioned even more preferable range, it is advantageous because the rolling can be stably performed and the resulted rolled product maintains its physical strength.

The temperature during the rolling is preferably 19° C. to 380° C., more preferably 22° C. to 365° C., and even more preferably 30° C. to 350° C.

When the temperature is lower than 19° C., the sufficient flow ability of the membrane for the rolling may not be obtained. When the temperature is higher than 380° C., the heated membrane has more then enough flow ability and thus the membrane may be rolled out excessively thin to thereby providing insufficient physical strength of the membrane. When the temperature is in the aforementioned even more preferable range, it is advantageous because the rolling can be stably performed and the resulted rolled product maintains its physical strength.

### <<Removal of Extrusion Aid>>

After the rolling, the film is heated to remove the extrusion aid from the film to thereby form an unbaked multilayer crystalline polymer film.

The temperature of the heating is suitably selected depending on the type of the aid for use without any restriction, but it is preferably 40° C. to 400° C., more preferably 60° C. to 350° C.

When the temperature is lower than 40° C., the aid may not be sufficiently dried. When the temperature is higher than 400° C., the properties of the membrane may be changed. When the temperature is within the aforementioned more preferably range, it is advantageous because the aid is sufficiently dried without changing the properties of the membrane.

In the case where polytetrafluoroethylene is used as the crystalline polymer and from which solvent naphtha is removed, for example, the temperature of the heating is preferably 150° C. to 280° C., and more preferably 200° C. to 255° C. The heating can be performed by the method in which the film is passed through a hot-blast drying oven.

The thickness of the unbaked multilayer crystalline polymer film produced in this manner can be appropriately adjusted depending on the intended thickness of the crystalline polymer microporous membrane to be produced as a final product. In the case where drawing will be performed in the later step, it is also necessary to adjust the thickness of the unbaked multilayer crystalline polymer film with consideration of the reduction in the thickness during the drawing.

For the production of the unbaked multilayer crystalline polymer film, the descriptions in “Polyflon Handbook” (published by DAIKIN INDUSTRIES, LTD., Revised Edition of the year 1983) may be suitably used as a reference, and applied.

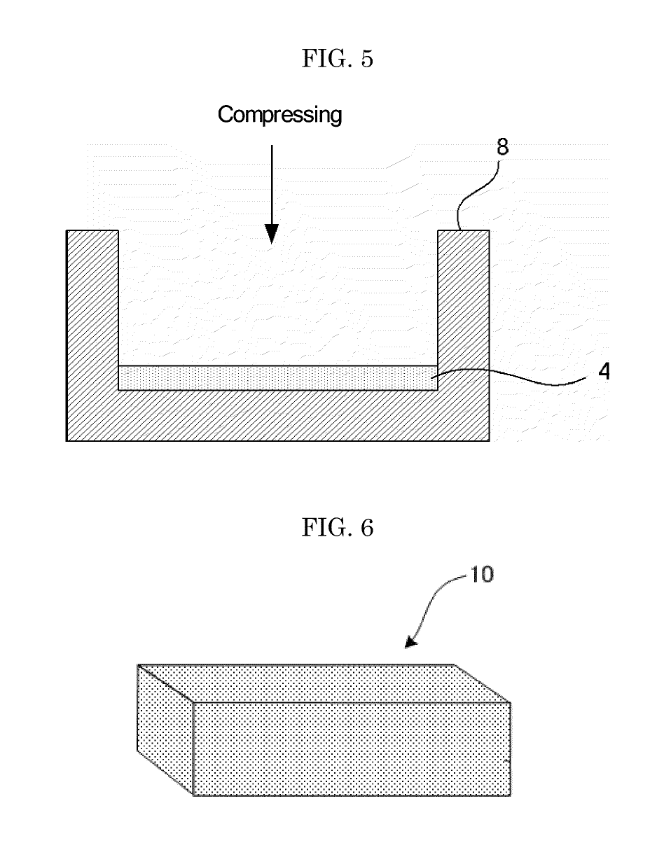

One example of the method for producing a crystalline polymer microporous membrane of the present invention will be explained with reference to FIGS. 5 to 7.

As shown in FIG. 6, a preforming body 10 consisted of a crystalline polymer layer of a single layer structure is prepared. The preforming body is made of a paste 4 (FIG. 5) in which a fluid lubricant, such as solvent naptha, and liquid paraffin, is added to fine PTFE powder that has been prepared by flocculation of a PTFE emulsified polymerization aqueous dispersion liquid having the average primary particle diameter of 0.2 μm to 0.4 μm. The amount of the fluid lubricant for use is varied depending on the lubricant for use, conditions for molding, and the like, but it is generally 15 parts by mass to 35 parts by mass relative to 100 parts by mass of the fine PTFE powder. If necessary, a colorant can be further added to form the preforming body.

At first, the paste 4 is placed in a box-shaped bottom metal mold 8 as illustrated in FIG. 5 to give a layer of the paste 4 in the bottom metal mold 8, and pressure is then applied to the paste 4, to thereby form a preforming body 10 (see FIG. 6).

In the manner mentioned above, the preforming body 10, which has been shaped in the size to be placed in a cylinder of a paste extruder, as shown in FIG. 6.

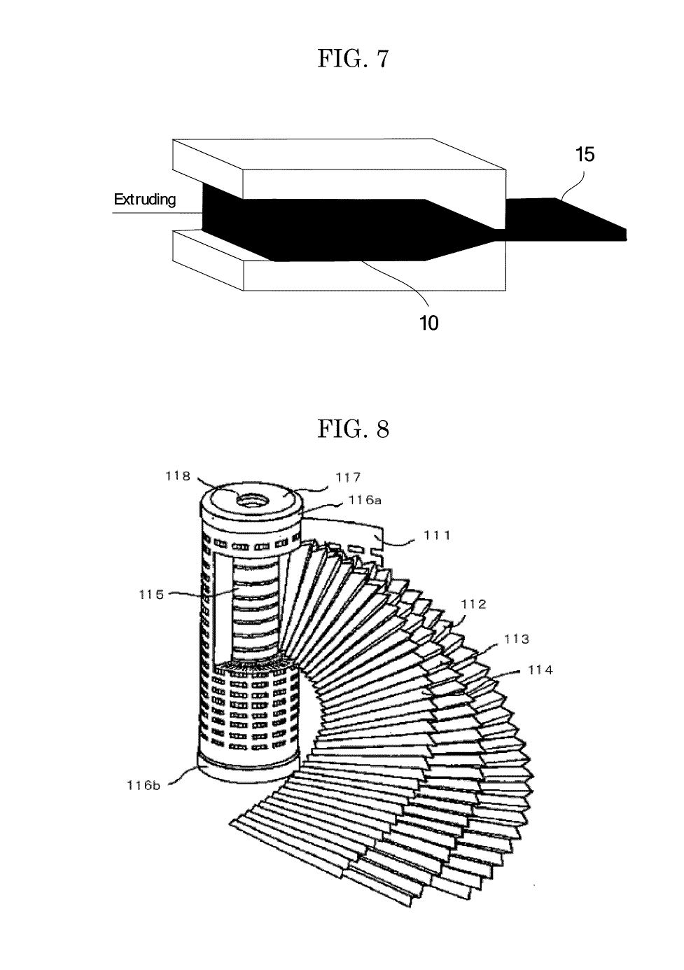

After placing the obtained preforming body 10 in the cylinder of the paste extruder shown in FIG. 7, the preforming body 10 is extruded in the direction shown with an arrow by means of a compressing member (not shown in the figure) to thereby extrude and form an extrusion body 15. The cylinder of the paste extruder shown in FIG. 7 has for example a rectangular shape in the size of 50 mm×100 mm at the cross-sectional direction that has right-angle to an axis, and a nozzle in the size of 50 mm×5 mm, which is formed by narrowing the outlet end of the cylinder.

A plurality of extrusion bodies 15 are formed in the manner mentioned above, these extrusion bodies 15 are laminated to form a laminate, and then the laminate is subjected to rolling using a calender roller or the like. After the rolling, the film (the laminate) is heated to remove the extrusion aid.

In this manner, a plurality of extrusion bodies are completely united to thereby form an unbaked multilayer polytetrafluoroethylene film (i.e., a non-heated laminate) each layer of which has a uniform thickness.

The thickness ratio of the layers of the laminate is substantially the same as the thickness ration of the extrusion bodies, which has been confirmed by a stereoscopic microscope.

After forming a plurality of preforming bodies, the preforming bodies are respectively shaped into a plurality of the extrusion bodies, and the laminate is formed by laminating these extrusion bodies. Therefore, the thickness ratio of layers of the crystalline polymer microporous membrane of the present invention is highly accurately matched with the thickness ration of the extrusion bodies.

### <Asymmetric Heating Step>

The asymmetric heating step is heating a surface of the laminate to perform asymmetric heating to give a temperature gradient in a thickness direction of the laminate.

The “a surface of the laminate” is suitably selected from surfaces of the laminate depending on the intended purpose without any restriction, but it is preferred that the surface of the laminate at the side where the layer containing the low crystalline polymer is present be heated. In the case where the layers containing the same material are provided on the both sides of the laminate, it is preferred that the side where the thinner layer than the other layer be heated.

Here, “asymmetric heating” means that the unbaked film (i.e. the unbaked laminate) in which two or more layers of the layer containing the first crystalline polymer (high crystalline polymer) and the layer containing the second crystalline polymer (low crystalline polymer) are laminated is heated at a temperature equal to or higher than the melting point of the baked film (i.e. the baked laminate) minus 5° C. (i.e. Tm of the baked film (the baked laminate)−5° C.), and equal to or lower than the melting point of the unbaked film (i.e. the baked laminate) plus 15° C. (i.e. Tm of the unbaked film (the baked laminate)+15° C.).

In the present specification, the “unbaked film (unbaked laminate)” means a film (a laminate) which has not been asymmetric heated. Moreover, the melting point of the unbaked film (the unbaked laminate) means a peak temperature of the endothermic curve obtained by the measurement using a differential scanning calorimeter. The melting point of the baked film (the baked laminate) and the melting point of the unbaked film (the unbaked laminate) are varied depending on a type, number average molecular weight, or the like of the crystalline polymer for use, but they are each preferably 50° C. to 450° C., more preferably 80° C. to 400° C.

The selection of such temperature range is explained as follows. In the case of polytetrafluoroethylene, for example, the melting point of the baked film (the baked laminate) is approximately 327° C. and the melting point of the unbaked film (the unbaked laminate) is approximately 346° C. Accordingly, to produce a semi-baked film (i.e. a semi-baked laminate) in which the film having the melting point of approximately 327° C. coexists with the film having the melting point of approximately 346° C., in the case of the polytetrafluoroethylene film, the film is preferably heated at 322° C. to 361° C., more preferably 327° C. to 346° C. For example, the film is heated 338° C.

In the asymmetric heating step, the method for applying thermal energy can be either a continuous application, or intermittent application in which thermal energy is dividedly applied in a few times. For asymmetric heating, it is necessary to give a temperature difference between the front surface of the film (the laminate) and the back surface of the film (the laminate). For this purpose, a method of intermittently applying the energy can be used for preventing the temperature of the back surface from increasing. On the other hand, in the case of the continuous application or discontinuous of the energy, it is effective to use a method of cooling the back surface at the same time as heating the front surface for maintaining the temperature gradient.

The method for applying thermal energy is suitably selected depending on the intended purpose without any restriction. Examples thereof include (1) a method of blowing hot air to the film (the laminate), (2) a method of bringing the film (the laminate) into contact with a heat medium (3) a method of bringing the film (the laminate) into contact with a heated member, (4) a method of irradiating the film (the laminate) with infrared rays, and (5) a method of heating the film (the laminate) by electromagnetic waves such as microwaves. Among them, (3) the method of bringing the film (the laminate) into contact with a heated member, and (4) the method of irradiating the film (the laminate) with infrared rays are preferable.

The heated member for use in (3) is preferably a heating roller. Use of the heating roller makes it possible to continuously perform asymmetric heating in an assembly-line operation in an industrial manner and makes it easier to control the temperature and maintain the apparatus for use. The temperature of the heating roller can be set to the temperature for forming the semi-baked film (the semi-baked laminate). The duration for the contact between the heating roller and the film is the period long enough to sufficiently perform intended asymmetric heating, and it is preferably 1 second to 120 seconds, more preferably 2 seconds to 110 seconds, and even more preferably 3 seconds to 100 seconds.

The aforementioned infrared irradiation (4) is suitably selected depending on the intended purpose without any restriction.

For the general definition of the infrared ray, “Infrared Ray in Practical Use” (published by Ningentorekishisha in 1992) may be referred to. Here, the infrared ray means an electromagnetic wave having a wavelength of 0.74 μm to 1,000 μm. Within this range, an electromagnetic wave having a wavelength of 0.74 μm to 3 μm is defined as a near-infrared ray, and an electromagnetic wave having a wavelength of 3 μm to 1,000 μm is defined as a far-infrared ray.

Since the temperature difference present between the front surface and the back surface of the film is preferable in the present invention, it is desirable to use a far-infrared ray that is advantageous for heating a surface layer.

A device for applying the infrared ray is suitably selected depending on the intended purpose without any restriction, provided that it can apply an infrared ray having a desired wavelength. Generally, an electric bulb (e.g. a halogen lamp) can be used as a device for applying near-infrared rays, while a heating element such as a ceramic, quartz, and metal oxidized surface can be used as a device for applying far-infrared rays.

Also, infrared irradiation enables to continuously perform the asymmetric heating in an assembly-line operation in an industrial manner and makes it easier to control the temperature and maintain the device. Moreover, since the infrared irradiation is performed in a noncontact manner, it is clean and does not allow defects such as pilling to arise.

The temperature of the film surface when irradiated with the infrared ray can be controlled by the output of the infrared irradiation device, the distance between the infrared irradiation device and the film surface, the irradiation time (conveyance speed) and/or the atmospheric temperature, and may be adjusted to the temperature at which the film is semi-baked. The temperature of the film surface is preferably 324° C. to 380° C., more preferably 335° C. to 360° C. When the temperature of the film surface is lower than 324° C., the crystallized state may not change and thus the pore diameter may not be able to be controlled. When the temperature is higher than 380° C., the entire film may melt, thus possibly causing extreme deformation or thermal decomposition of the polymer.

The duration for the infrared irradiation is suitably adjusted depending on the intended purpose without any restriction, but it is long enough to perform sufficient semi-baking, preferably 30 seconds to 120 seconds, more preferably 45 seconds to 90 seconds, and even more preferably 60 seconds to 80 seconds.

The infrared irradiation for the asymmetric heating may be carried out continuously, or intermittently divided into a few times.

As the temperature gradient of the film (the laminate) in the thickness direction thereof, the temperature difference between the front surface and the back surface is preferably 30° C. or higher, more preferably 50° C. or higher.

In the case where the back surface of the film (the laminate) is continuously heated, it is preferred that the front surface be cooled at the same time as heating the back surface to maintain the temperature gradient between the front surface and back surface of the film (the laminate).

The method for cooling the front surface is suitably selected depending on the intended purpose without any restriction, and various methods can be used. Examples of such method include a method of allowing the front surface to be in contact with a refrigerant, a method of allowing the front surface to be in contact with a cooled material, and a method of standing the front surface to cool. However, a method of allowing the surface of the film (the laminate) to be in contact with a cooling member is not preferable because the surface of the cooling member to be contact is heated by far infrared rays.

In the case where the asymmetric heating step is carried out intermittently, moreover, it is preferred that the back surface of the film (the laminate) is heated and cooled intermittently to prevent the temperature increase on the surface.

### <Drawing Step>

The drawing step is drawing the film (the laminate).

The drawing is preferably performed in the both the length direction and width direction. The film (the laminate) may be drawn in the length direction, followed by drawn in the width direction, or may be drawn in the biaxial direction at the same time.

In the case where the film (the laminate) is sequentially drawn in the length direction and width direction, it is preferred that the film (the laminate) be drawn in the length direction first, then be drawn in the width direction.

The extension rate of the film (the laminate) in the length direction is preferably 1.2 times to 50 times, more preferably 1.5 times to 40 times, and even more preferably 2.0 times to 10 times. The temperature for the drawing in the length direction is preferably 35° C. to 330° C., more preferably 45° C. to 320° C., and even more preferably 55° C. to 310° C.

The extension rate of the film (the laminate) in the width direction is preferably 1.2 times to 50 times, more preferably 1.5 times to 40 times, even more preferably 2.0 times to 30 times, and particularly preferably 2.5 times to 10 times. The temperature for the drawing in the width direction is preferably 35° C. to 330° C., more preferably 45° C. to 315° C., and even more preferably 60° C. to 300° C.

The draw rate of the film (the laminate) in terms of the area thereof is preferably 1.5 times to 2,500 times, more preferably 2 times 2,000 times, and even more preferably 2.5 times to 100 times. Before the drawing is performed on the film (the laminate), the film (the laminate) may be pre-heated at the temperature equal to or lower than the temperature for the drawing.

Moreover, heat setting may be performed after drawing, if necessary. The temperature for heat setting is generally preferably equal to or higher than the temperature for drawing, but the lower than the melting point of the crystalline polymer for use.

In the case where the crystalline polymer is a fluororesin such as PTFE, the heat setting is preferably performed by heating at the temperature equal to or higher than the melting point thereof.

In the case where the crystalline polymer is a fluororesin such as PTFE, the heat setting is preferably performed by heating at the temperature equal to or higher than the melting point thereof.

The crystalline polymer microporous membrane of the present invention can be used for various purposes, but it is particularly preferably used as a filtration filter explained below.

### (Filtration Filter)

The filtration filter of the present invention contains the crystalline polymer microporous membrane of the present invention.

When the crystalline polymer microporous membrane of the present invention is arranged as a filtration filter, the surface of the membrane (i.e., the surface thereof having the larger average pore diameter than that of the other surface) faces the inlet side to perform filtration. By using the surface having the larger average pore diameter (i.e. the surface of the membrane) for the inlet side to perform filtration, particles can efficiently captured.

Moreover, since the crystalline polymer microporous membrane of the present invention has a large specific surface area, fine particles introduced from such surface are removed by absorption or deposition before they reach the portion of the minimum pore diameter. Accordingly, the filtration filter can maintain its high filtration efficiency for long period of time while preventing clogging.

The filtration filter of the present invention is preferably processed into a pleated form. By arranging the filtration filter in the pleated form, the effective surface area of the filter per cartridge can be increased.

FIG. 8 is a developed view showing a structure of an element-exchange type pleated filter cartridge element. Sandwiched between two membrane supports 112 and 114, a microfiltration membrane 113 is corrugated and wound around a core 115 having multiple liquid-collecting slots, and a cylindrical object is thus formed. An outer circumferential cover 111 is provided outside the foregoing members so as to protect the microfiltration membrane. At both ends of the cylindrical object, the microfiltration membrane is sealed with end plates 116a and 116b. The end plates are connected to a sealing portion of a filter housing (not shown), with a gasket 117 placed in between. A filtered liquid is collected through the liquid-collecting slots of the core and discharged from a fluid outlet 118.

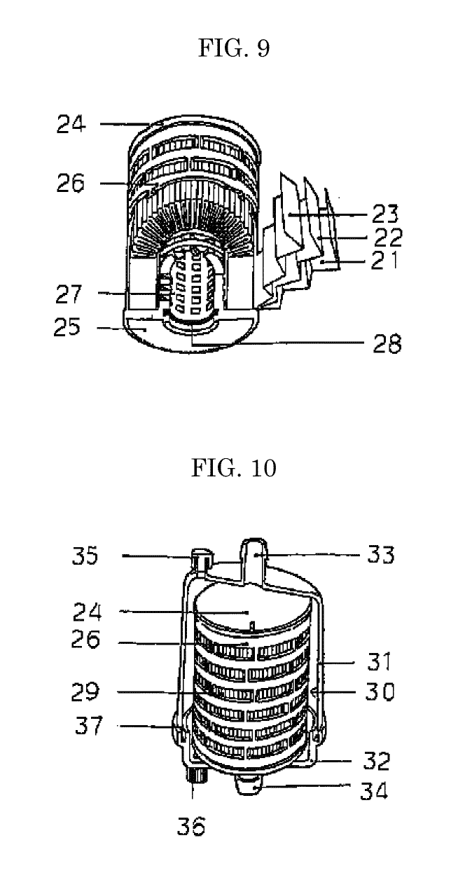

Capsule-type pleated cartridges are shown in FIGS. 9 and 10.

FIG. 9 is a developed view showing the overall structure of a microfiltration membrane filter element before installed in a housing of a capsule-type cartridge. Sandwiched between two supports 21 and 23, a microfiltration membrane 22 is corrugated and wound around a filter element core 27 having multiple liquid-collecting slots, and a cylindrical object is thus formed. A filter element cover 26 is provided outside the foregoing members so as to protect the microfiltration membrane. At both ends of the cylindrical object, the microfiltration membrane 22 is sealed with an upper end plate 24 and a lower end plate 25.

FIG. 10 shows the structure of a capsule-type pleated cartridge in which the filter element 30 has been installed in a housing so as to form a single unit. The lower end plate is connected in a sealed manner to a water-collecting tube (not shown) at the center of the housing base by means of an O-shaped ring 28. A liquid enters the housing from a liquid inlet nozzle and passes through a filter medium 29, then the liquid is collected through the liquid-collecting slots of the filter element core 27 and discharged from a liquid outlet nozzle 34. In general, the housing base and the housing cover are thermally fused in a liquid-tight manner at a fusing portion 37.

FIG. 9 shows an instance where the lower end plate and the housing base are connected in a sealed manner by means of the O-shaped ring. It should be noted that the lower end plate and the housing base may be connected in a sealed manner by thermal fusing or with an adhesive. Also, the housing base and the housing cover may be connected in a sealed manner with an adhesive as well as by thermal fusing. FIGS. 8 to 10 show specific examples of microfiltration cartridges, and note that the present invention is not confined to the examples shown in these drawings.

Having a high filtering function and long lifetime as described above, the filtration filter of the present invention enables a filtration device to be compact. In a conventional filtration device, multiple filtration units are used in parallel so as to offset the short filtration life; use of the filter of the present invention for filtration makes it possible to greatly reduce the number of filtration units used in parallel. Furthermore, since it is possible to greatly lengthen the period of time for which the filter can be used without replacement, it is possible to cut costs and time necessary for maintenance.

The filtration filter of the present invention can be used in a variety of situations where filtration is required, notably in microfiltration of gases, liquids, etc. For instance, the filter can be used for filtration of corrosive gases and gases for use in the semiconductor industry, and filtration and sterilization of cleaning water for use in the electronics industry, water for medical uses, water for pharmaceutical production processes and water for foods and drinks. It should be particularly noted that since the filtration filter of the present invention is superior in heat resistance and chemical resistance, the filtration filter can be effectively used for high-temperature filtration and filtration of reactive chemicals, for which conventional filters cannot be suitably used.

### EXAMPLES

Examples of the present invention will be explained hereinafter, but these examples shall not be construed as limiting to the scope of the present invention in any way.

### Example 1

### <Preparation of Microporous Membrane>

### —Preparation of Preforming Body (Molding Step)—

To 100 parts by mass of polytetrafluoroethylene fine powder (F106, manufactured by DAIKIN INDUSTRIES, LTD., crystallinity: 98.5%) serving as a high crystalline polymer, 23 parts by mass of hydrocarbon oil (ISOPAR H, manufactured by Esso Sekiyu K.K.) serving as an extrusion aid was added to prepare Paste 1.

To 100 parts by mass of polytetrafluoroethylene fine powder (F205, manufactured by DAIKIN INDUSTRIES, LTD., crystallinity: 93.7%) serving as low crystalline polymer, 20 parts by mass of hydrocarbon oil (ISOPAR H, manufactured by Esso Sekiyu K.K.) serving as an extrusion aid was added to prepare Paste 2.

Then, Paste 1 was laid and compressed at the pressure of 0.5 MPa, pressure application duration of 10 seconds, and the highest reaching temperature of 36° C. to thereby prepare Preforming Body 1 having a thickness of 70 mm.

Thereafter, Paste 2 was laid and compressed at the pressure of 0.5 MPa, pressure application duration of 10 seconds, and the highest reaching temperature of 35° C. to thereby prepare Preforming Body 2 having a thickness of 70 mm.

Note that, the thickness and crystallinity of the preforming body were measured in the following manners.

### —Method for Measuring Thickness of Preforming Body—

The thickness of the preforming body was measured with a metal linear scale in accordance with the method described in JIS B 7516.

### —Measuring Method of Crystallinity—

The crystallinity of the preforming body was measured by means of ACCUPYC 1330 manufactured by Shimadzu Corporation.

The measuring sample of the preforming body was stored in a low humidity storage having the temperature of 25° C. and the relative humidity of 1% RH 24 hours before the measurement to prevent absorption of moisture. As an amount of the preforming body used as a sample for the measurement, the preforming body was weighted to have a weight ranging from 0.1 g to 1.0 g. In the case where the measuring sample was in the form of a film, the measurement of the sample could be performed by rolling the sample put to form a rod sample having a width of 8 mm and length of a few centimeters to about twenty centimeters, and placing the rod sample in a sample tube.

### —Preparation of Unbaked Film (Film Forming Step)—

The prepared Preforming Body 1 was inserted in a square cylinder, which was a paste extrusion metal mold, and was extruded into a sheet at the temperature of 45° C., and the pressure of 5.0 MPa to thereby prepare Extrusion Body 1 having a thickness of 3.0 mm.

The prepared Preforming Body 2 was inserted in a square cylinder, which was a paste extrusion metal mold, and was extruded in the shape of a sheet at the temperature of 45° C., and the pressure of 5.0 MPa to thereby prepare Extrusion Body 2 having a thickness of 3.0 mm.

The prepared Extrusion Body 1 and Extrusion Body 2 were used to prepare a laminate so as to have three layers, i.e., Extrusion Body 1, Extrusion Body 2, and Extrusion Body 1, laminated in this order, where the thicknesses of the laminated layers (i.e., Extrusion Body 1, Extrusion Body 2, and Extrusion Body 1) were 6.0 mm, 3.0 mm, and 6.0 mm, respectively, and the thickness ratio (the thickness of Extrusion Body 1/the thickness of Extrusion Body 2/the thickness of Extrusion Body 1) was about 2/1/2. The prepared laminate was subjected to calendering at the pressure of 35.0 MPa by calender rollers heated at 60° C. to thereby prepare a multilayer polytetrafluoroethylene film. The multilayer polytetrafluoroethylene film was passed through a hot drying hearth having the temperature of 250° C. to dry and remove the extrusion aid, to thereby respectively prepare an unbaked multilayer polytetrafluoroethylene film having an average thickness of 100 μm, an average width of 250 mm, and specific gravity of 1.45.

Note that, thicknesses of the extrusion body and the unbaked polytetrafluoroethylene film were measured in the following manners.

### —Measurement of Thickness of Extrusion Body—

The extrusion body was made frozen and cut, and the cross-section of the cut extrusion body was observed by a scanning electron microscope (SEM)(Hitachi S-4700, manufactured by Hitachi, Ltd.) to thereby measure a thickness of the extrusion body.

### —Measurement of Thickness of Unbaked Multilayer Polytetrafluoroethylene Film—

The unbaked multilayer polytetrafluoroethylene film was made frozen and cut, and the cross-section of the cut unbaked multilayer polytetrafluoroethylene film was observed by a scanning electron microscope (SEM)(Hitachi S-4700, manufactured by Hitachi, Ltd.) to thereby measure a thickness of the unbaked multilayer polytetrafluoroethylene film.

### —Preparation of Semi-Baked Film (Asymmetric Heating Step)—

One surface of the obtained unbaked multilayer polytetrafluoroethylene film was heated for 26 seconds by a roller (surface material: SUS316) whose temperature was maintained at 338° C. to prepare a semi-baked film.

### —Preparation of Polytetrafluoroethylene Microporous Membrane (Drawing Step)—

The obtained semi-baked film was passed through between rollers at 200° C. to draw 3 times the length in the length direction, and the drawn film was wound up around a wind roll. Thereafter, the both edges of the drawn film were nipped with clips to draw 3 times the length in the width direction at 200° C. Thereafter, the drawn film was subjected to heat setting at 360° C. In the manner as described, a polytetrafluoroethylene microporous membrane of Example 1 was prepared. The drawn rate of the obtained polytetrafluoroethylene microporous membrane in terms of the area was 9.0 times.

The fact that the obtained polytetrafluoroethylene microporous membrane has a plurality of pores whose average pore diameter was continuously or discontinuously changed in the thickness direction of each layer was confirmed by freezing the prepared microporous membrane, cutting the frozen membrane, and observing the cross-section of the cut membrane under a scanning electron microscope (SEM)(Hitachi S-4700, manufactured by Hitachi, Ltd.). This confirmation was performed in the same manner in Examples 2 to 6.

### Example 2

### <Preparation of Microporous Membrane>

A polytetrafluoroethylene microporous membrane of Example 2 was prepared in the same manner as in Example 1, provided that instead of laminating Extrusion Body 1 and Extrusion Body 2 in the order of Extrusion Body 1/Extrusion Body 2/Extrusion Body 1, so as to have thicknesses (Extrusion Body 1, Extrusion Body 2, and Extrusion Body 1) of 6.0 mm, 3.0 mm, 6.0 mm, respectively, and the thickness ratio (thickness of Extrusion Body 1/Extrusion Body 2/Extrusion Body 1) of about 2/1/2, Extrusion Body 1 and Extrusion Body 2 were laminated so as to have thicknesses (Extrusion Body 1, and Extrusion Body 2) of 12 mm, and 3 mm, respectively, and the thickness ratio (the thickness of Extrusion Body 1/the thickness of Extrusion Body 2) of 4/1 to form a laminate of two layers, and instead of heating the obtained unbaked multilayer polytetrafluoroethylene film for 26 seconds by the roller (surface material: SUS316) whose temperature was maintained at 338° C., the surface of the unbaked multilayer polytetrafluoroethylene film at the side of Extrusion Body 2 was heated at the film surface temperature of 340° C. for 1 minute by near infrared rays emitted from a halogen heater to which a tungsten filament was built in.

### Example 3

### <Preparation of Microporous Membrane>

A polytetrafluoroethylene microporous membrane of Example 3 was prepared in the same manner as in Example 1, provided that instead of laminating Extrusion Body 1 and Extrusion Body 2 in the order of Extrusion Body 1/Extrusion Body 2/Extrusion Body 1, so as to have thicknesses (Extrusion Body 1, Extrusion Body 2, and Extrusion Body 1) of 6.0 mm, 3.0 mm, 6.0 mm, respectively, and the thickness ratio (thickness of Extrusion Body 1/Extrusion Body 2/Extrusion Body 1) of about 2/1/2, Extrusion Body 1 and Extrusion Body 2 were laminated so as to have thicknesses (Extrusion Body 1, Extrusion Body 2, Extrusion Body 1) of 6.0 mm, 3.0 mm, and 3.0 mm, respectively, and the thickness ratio (the thickness of Extrusion Body 1/the thickness of Extrusion Body 2/the thickness of Extrusion Body 1) of 2/1/1 to form a laminate of three layers. Note that, a surface of the unbaked multilayer polytetrafluoroethylene film at the side where Extrusion Body 1 having a thickness of 3.0 mm was present was heated in the asymmetric heating step.

### Example 4

### <Preparation of Microporous Membrane>

A polytetrafluoroethylene microporous membrane of Example 4 was prepared in the same manner as in Example 1, provided that instead of laminating Extrusion Body 1 and Extrusion Body 2 in the order of Extrusion Body 1/Extrusion Body 2/Extrusion Body 1, so as to have thicknesses (Extrusion Body 1, Extrusion Body 2, and Extrusion Body 1) of 6.0 mm, 3.0 mm, 6.0 mm, respectively, and the thickness ratio (thickness of Extrusion Body 1/Extrusion Body 2/Extrusion Body 1) of about 2/1/2, Extrusion Body 1 and Extrusion Body 2 were laminated so as to have thicknesses (Extrusion Body 1, Extrusion Body 2, Extrusion Body 1) of 12.0 mm, 3.0 mm, and 6.0 mm, respectively, and the thickness ratio (the thickness of Extrusion Body 1/the thickness of Extrusion Body 2/the thickness of Extrusion Body 1) of 2/0.5/1 to form a laminate of three layers. Note that, a surface of the unbaked multilayer polytetrafluoroethylene film at the side where Extrusion Body 1 having a thickness of 6.0 mm was present was heated in the asymmetric heating step.

### Example 5

### <Preparation of Microporous Membrane>

A polytetrafluoroethylene microporous membrane of Example 5 was prepared in the same manner as in Example 1, provided that instead of using polytetrafluoroethylene as the high crystalline polymer, CD123 (crystallinity: 98.7%), manufactured by ASAHI GLASS CO., LTD. was used as the high crystalline polymer.

### Example 6

A polytetrafluoroethylene microporous membrane of Example 6 was prepared in the same manner as in Example 1, provided that instead of using F205 manufactured by DAIKIN INDUSTRIES, LTD. as the low crystalline polymer, F201 (crystallinity: 93.1%) manufactured by DAIKIN INDUSTRIES, LTD. was used as the low crystalline polymer.

### Comparative Example 1

### <Preparation of Microporous Membrane>

A polytetrafluoroethylene microporous membrane of Comparative Example 1 was prepared in the same manner as in Example 1, provided that the asymmetric heating treatment was not performed on the unbaked multilayer polytetrafluoroethylene film.

### Comparative Example 2

### <Preparation of Microporous Membrane>

A polytetrafluoroethylene microporous membrane of Comparative Example 2 was prepared in the same manner as in Example 1, provided that instead of laminating Extrusion Body 1 and Extrusion Body 2 in the order of Extrusion Body 1/Extrusion Body 2/Extrusion Body 1, so as to have thicknesses (Extrusion Body 1, Extrusion Body 2, and Extrusion Body 1) of 6.0 mm, 3.0 mm, 6.0 mm, respectively, and the thickness ratio (thickness of Extrusion Body 1/Extrusion Body 2/Extrusion Body 1) of about 2/1/2, Extrusion Body 1 and Extrusion Body 2 were laminated so as to have thicknesses (Extrusion Body 2, Extrusion Body 1) of 12.0 mm, and 3.0 mm, respectively, and the thickness ratio (the thickness of Extrusion Body 2/the thickness of Extrusion Body 1) of 4/1 to form a laminate of two layers. Note that, a surface of the unbaked multilayer polytetrafluoroethylene film at the side where Extrusion Body 1 was present was heated in the asymmetric heating step.

### Comparative Example 3

### <Preparation of Microporous Membrane>

A polytetrafluoroethylene microporous membrane of Comparative Example 3 was prepared in the same manner as in Example 1, provided that instead of laminating Extrusion Body 1 and Extrusion Body 2 in the order of Extrusion Body 1/Extrusion Body 2/Extrusion Body 1, so as to have thicknesses (Extrusion Body 1, Extrusion Body 2, and Extrusion Body 1) of 6.0 mm, 3.0 mm, 6.0 mm, respectively, and the thickness ratio (thickness of Extrusion Body 1/Extrusion Body 2/Extrusion Body 1) of about 2/1/2, Extrusion Body 1 and Extrusion Body 2 were laminated in the order of Extrusion Body 2/Extrusion Body 1/Extrusion Body 2 so as to have thicknesses (Extrusion Body 2, Extrusion Body 1, and Extrusion Body 2) of 9.0 mm, 3.0 mm, and 3.0 mm, respectively, and the thickness ratio (the thickness of Extrusion Body 2/the thickness of Extrusion Body 1/the thickness of Extrusion Body 2) of 3/1/1 to form a laminate of three layers. Note that, a surface of the unbaked multilayer polytetrafluoroethylene film at the side where Extrusion Body 1 having a thickness of 3.0 mm was present was heated in the asymmetric heating step.

### Referential Example 1

### <Preparation of Microporous Membrane>

### —Preparation of Preforming Body—

To 100 parts by mass of polytetrafluoroethylene fine powder (F106, manufactured by DAIKIN INDUSTRIES, LTD., crystallinity: 98.5%) serving as a high crystalline polymer, 23 parts by mass of hydrocarbon oil (ISOPAR H, manufactured by Esso Sekiyu K.K.) serving as an extrusion aid was added to prepare Paste 1.

To 100 parts by mass of polytetrafluoroethylene fine powder (F205, manufactured by DAIKIN INDUSTRIES, LTD., crystallinity: 93.7%) serving as low crystalline polymer, 23 parts by mass of hydrocarbon oil (ISOPAR H, manufactured by Esso Sekiyu K.K.) serving as an extrusion aid was added to prepare Paste 2.

Then, Paste 1 and Paste 2 were laid in the order of Paste 1/Paste 2/Paste 1 to have a thickness ratio (the thickness of Paste 1/the thickness of Paste 2/the thickness of Paste 1) of 2/1/2, and compressed under the conditions that the applied pressure was 0.5 MPa, the duration for applying the pressure was 10 seconds, and the highest reaching temperature was 36° C., to thereby prepare a preforming body of three-layer structure.

### —Preparation of Unbaked Film—

The prepared preforming body was inserted in a square cylinder, which was a paste extrusion metal mold, and the paste of the multilayer structure was then extruded into a sheet at the temperature of 45° C. and the pressure of 5.0 MPa. The resultant was then subjected to calendering at the pressure of 35.0 MPa by calender rollers heated at 60° C. to thereby prepare a multilayer polytetrafluoroethylene film. The obtained multilayer polytetrafluoroethylene film was passed through a hot drying hearth having the temperature of 250° C. to dry and remove the extrusion aid, to thereby prepare an unbaked multilayer polytetrafluoroethylene film having an average thickness of 100 μm, an average width of 250 mm, and specific gravity of 1.45.

### —Preparation of Semi-Baked Film—

One surface of the obtained unbaked multilayer polytetrafluoroethylene film was heated for 30 seconds by a roller (surface material: SUS316) whose temperature was maintained at 340° C. to prepare a semi-baked film.

### —Preparation of Polytetrafluoroethylene Microporous Membrane—

The obtained semi-baked film was passed through between rollers at 300° C. to draw 3 times the length in the length direction, and the drawn film was wound up around a wind roll. Thereafter, the both edges of the drawn film were nipped with clips to draw at 300° C. to 3 times the length in the width direction. Then, the drawn film was subjected to heat setting at 380° C. The drawn magnification of the obtained drawn film in terms of the area was 9.0 times. In the manner as described, the polytetrafluoroethylene of Referential Example 1 was prepared.

### Comparative Example 4

### <Preparation of Microporous Membrane>

A polytetrafluoroethylene microporous membrane of Comparative Example 4 was prepared in the same manner as in Referential Example 1, provided that instead of laying and compressing Paste 1 and Paste 2 to have a thickness ratio (thickness of Paste 1/thickness of Paste 2/thickness of Paste 1) of 2/1/2 to prepare a preforming body of the three-layer structure, Paste 1 and Paste 2 were laid and compressed to have a thickness ratio (thickness of Paste 2/thickness of Paste 1) of 4/1 to thereby prepare a preforming body of two-layer structure. Note that, a surface of the preforming body at the side of Paste 1 was subjected to asymmetric heating.

### Comparative Example 5

### <Preparation of Microporous Membrane>

A polytetrafluoroethylene microporous membrane of Comparative Example 5 was prepared in the same manner as in Referential Example 1, provided that instead of laying and compressing Paste 1 and Paste 2 to have a thickness ratio (thickness of Paste 1/thickness of Paste 2/thickness of Paste 1) of 2/1/2 to prepare a preforming body of three-layer structure, Paste 1 and Paste 2 were laid and compressed to have a thickness ratio (from the front surface, thickness of Paste 2/thickness of Paste 1/thickness of Paste 2) of 3/1/1 to thereby prepare a preforming body of three-layer structure.

Since the low crystalline polymer layers were provided in the both outer sides of the microporous membrane of Comparative Example 5, there were problems that the membrane stuck to the calendering roller, as well as being torn.

Note that, a surface of the preforming body at the side of the paste 2 whose thickness was thin was subjected to asymmetric heating.

The prepared microporous membranes of Examples 1 to 6, Comparative Examples 1 to 5, and Referential Example 1 were each subjected to confirmation of “formation of a plurality of pores piercing through in the thickness direction”, measurements of thickness of each layer, measurements of diameters of pores in the layer at the non-heated side, filtration test, flow rate test, durability test, and curl test.

### <Confirmation of “Formation of a Plurality of Pores Piercing Through in the Thickness Direction”>

The “formation of a plurality of pores piercing through in the thickness direction” was confirmed by freezing each microporous membrane, cut the frozen membrane, and observing the cross-section of the cut membrane under a scanning electron microscope (SEM)(Hitachi S-4700, manufactured by Hitachi, Ltd.).

### <Measurement of Thickness of Each Layer>

Microporous membranes of Example 1 to 6, Comparative Example 1 to 5, and Referential Example 1 were each frozen, and cut. Then, the cross-section of the cut membrane was observed under a scanning electron microscope (SEM)(Hitachi S-4700, manufactured by Hitachi, Ltd.) to measure a thickness of each layer. The results are shown in Table 1.

Note that, in the case where an intermediate layer containing the high crystalline polymer and the low crystalline polymer was present at an interface of layers, the intermediate layer was categorized neither as the layer containing the high crystalline polymer, nor as the layer containing the low crystalline polymer.

TABLE 1

| | | Nonheated surface side | | | | Heated surface side | |
|---|---|---|---|---|---|---|---|
| | | | Thickness | | Thickness | | Thickness |
| | | Polymer | (μm) | Polymer | (μm) | Polymer | (μm) |
| Ex. 1 | Microporous | F106 | 28 | F205 | 14 | F106 | 27 |
| | membrane | | | | | | |
| | Rolled | F106 | 42 | F205 | 21 | F106 | 42 |
| | laminate | | | | | | |
| Ex. 2 | Microporous | F106 | 55 | — | — | F205 | 14 |
| | membrane | | | | | | |
| | Rolled | F106 | 80 | — | — | F205 | 20 |
| | laminate | | | | | | |
| Ex. 3 | Microporous | F106 | 34 | F205 | 17 | F106 | 17 |
| | membrane | | | | | | |
| | Rolled | F106 | 50 | F205 | 25 | F106 | 25 |
| | laminate | | | | | | |
| Ex. 4 | Microporous | F106 | 39 | F205 | 10 | F106 | 20 |
| | membrane | | | | | | |
| | Rolled | F106 | 58 | F205 | 15 | F106 | 30 |
| | laminate | | | | | | |
| Ex. 5 | Microporous | CD123 | 28 | F205 | 14 | CD123 | 28 |
| | membrane | | | | | | |
| | Rolled | CD123 | 42 | F205 | 21 | CD123 | 41 |
| | laminate | | | | | | |
| Ex. 6 | Microporous | F106 | 29 | F201 | 15 | F106 | 28 |
| | membrane | | | | | | |
| | Rolled | F106 | 42 | F201 | 22 | F106 | 43 |
| | laminate | | | | | | |
| Comp. | Microporous | F106 | 28 | F205 | 14 | F106 | 27 |
| Ex. 1 | membrane | | | | | | |
| | Rolled | F106 | 42 | F205 | 21 | F106 | 42 |
| | laminate | | | | | | |
| Comp. | Microporous | F205 | 55 | — | — | F106 | 15 |
| Ex. 2 | membrane | | | | | | |
| | Rolled | F205 | 80 | — | — | F106 | 20 |
| | laminate | | | | | | |
| Comp. | Microporous | F205 | 42 | F106 | 14 | F205 | 14 |
| Ex. 3 | membrane | | | | | | |
| | Rolled | F205 | 63 | F106 | 20 | F205 | 21 |
| | laminate | | | | | | |
| Ref. | Microporous | F106 | 28 | F205 | 15 | F106 | 28 |
| Ex. 1 | membrane | | | | | | |
| | Rolled film | F106 | 40 | F205 | 21 | F106 | 40 |
| Comp. | Microporous | F205 | 42 | — | — | F106 | 16 |
| Ex. 4 | membrane | | | | | | |
| | Rolled film | F205 | 81 | — | — | F106 | 20 |
| Comp. | Microporous | F205 | 41 | F106 | 14 | F205 | 15 |
| Ex. 5 | membrane | | | | | | |
| | Rolled film | F205 | 62 | F106 | 19 | F205 | 21 |

By comparing the results of Examples 1 to 6 with the results of Referential Example 1 and Comparative Examples 4 to 5 presented in Table 1, it is found that the production method of the present invention can accurately produce a crystalline polymer microporous membrane formed of a laminate having an intended thickness ratio by controlling thicknesses of the extrusion bodies.

### <Measurement of Diameters of Pores in Layer at Side of Non-heated Surface>

The most frequent value of the pore diameter in the layer at the non-heated side of each of the crystalline polymer microporous membranes of Examples 1 to 6, Comparative Examples 1 to 5, and Referential Example 1 was measured by means of Perm-Porometer manufactured by Porous Materials, Inc. The results are shown in Table 2.

### <Filtration Test>

The filtration test was performed on the crystalline polymer microporous membranes of Examples 1 to 6, Comparative Examples 1 to 5, and Referential Example 1. An aqueous solution containing 0.01% by mass of gold colloid (average particle size of 0.1 μm) was filtered through each of the membranes with a differential pressure of 10 kPa. The results are shown in Table 2.

### <Flow Rate Test>

The flow rate test was performed on the crystalline polymer microporous membranes of Examples 1 to 6, Comparative Examples 1 to 5, and Referential Example 1. Specifically, IPA was passed through each membrane with a differential pressure of 100 kPa, and the permeation amount of IPA per unit area (m²) per unit time (min) was determined as a flow rate (L·m⁻²·min⁻¹). The results are shown in Table 2.

### <Durability Test>

The durability test was performed on the crystalline polymer microporous membranes of Examples 1 to 6, Comparative Examples 1 to 5, and Referential Example 1. As the durability test, a pealing test using a mending tape was performed. The results were evaluated as: A, no pealing or fiber depositions was observed on the tape from the both sides of the membrane; B, pealing or fiber depositions was observed on the tape from only one side of the membrane; and C, pealing or fiber depositions was observed on the tape from the both sides of the membrane. The results are shown in Table 2.

### <Curl Test>

The curl test was performed on the crystalline polymer microporous membranes of Examples 1 to 6, Comparative Examples 1 to 5, and Referential Example 1. Each microporous membrane was placed on a flat place, and visually evaluated whether or not the microporous membrane was curled. It was evaluated as: A, no curling; B, slightly curled but curling disappeared when the membrane was placed on the flat place; and C, the membrane was curled even when it was placed on the flat place. The results are shown in Table 2.

TABLE 2

| | Pore | Filtration | Flow rate | | |
|---|---|---|---|---|---|
| | diameter | test | test | Durability | Curl |
| | (μm) | (mL/cm²) | (L/(m² · min)) | test | test |
| Ex. 1 | 0.049 | 1,220 | 5.4 | A | A |
| Ex. 2 | 0.052 | 1,435 | 6.1 | B | B |
| Ex. 3 | 0.065 | 1,256 | 7.1 | A | A |
| Ex. 4 | 0.059 | 1,460 | 6.6 | A | A |
| Ex. 5 | 0.057 | 1,557 | 5.3 | A | A |
| Ex. 6 | 0.077 | 1,698 | 8.6 | A | A |
| Comp. | 0.96 | 225 | 50.4 | A | A |
| Ex. 1 | | | | | |
| Comp. | 0.051 | 86 | 0.1 | B | C |
| Ex. 2 | | | | | |
| Comp. | 0.049 | 115 | 0.6 | C | B |
| Ex. 3 | | | | | |
| Ref. | 0.037 | 1,200 | 5.2 | A | A |
| Ex. 1 | | | | | |
| Comp. | 0.049 | 120 | 0.4 | B | C |
| Ex. 4 | | | | | |
| Comp. | 0.048 | 130 | 0.5 | C | B |
| Ex. 5 | | | | | |

From the results shown in Table 2, it was found that the microporous membrane of Comparative Example 1 substantially caused clogging at 225 mL/cm². Moreover, the membranes of Comparative Examples 2 to 5 substantially caused clogging before its filtration rate reaching 1,000 mL/cm². Compared to these, the membranes of Examples 1 to 6 could filter respectively up to 1,220 mL/cm², 1,435 mL/cm², 1,256 mL/cm², 1,460 mL/cm², 1,557 mL/cm², and 1,698 mL/cm², which showed that use of the crystalline polymer microporous membrane of the present invention significantly improves the service life of the filter.

Moreover, based on the results shown in Table 2, the microporous membrane of Comparative Example 1 had a high flow rate because of its large pore diameters, but the microporous membranes of Comparative Examples 2 to 5 had low flow rate such as 1 L·m⁻²·min⁻¹ or less. Compared to these, the microporous membranes of Examples 1 to 6 which had the approximately same pore diameter to those of Comparative Examples 2 to 5 had higher flow rate than those of Comparative Examples 2 to 5, by a few times or more. Accordingly, it was found that use of the crystalline polymer microporous membrane of the present invention can achieve high flow rate.

Moreover, based on the results shown in Table 2, it is clear that the microporous membranes of Example 2, and Comparative Example 2, in which the low crystalline polymer layers were exposed had the fiber deposition to the tape, and the microporous membranes of Comparative Examples 3 and 5 in each of which the low crystalline polymer layers were provided at both surfaces gave the fiber deposition to the tape from the both sides, which had low durability. In contrast to these, the microporous membranes of Examples 1, 3 to 6, and Comparative Example 1 had no pealing or fiber deposition, and had high durability. Accordingly, it was found that the crystalline polymer microporous membrane of the present invention can attain high durability.

Furthermore, according to the results shown in Table 2, the two-layer laminate membranes had curling, but three-layer laminate membranes were not curled. Accordingly, it was found that curling can be prevented by using the crystalline polymer microporous membranes of Examples 1 and 3 to 5.

The crystalline polymer microporous membrane of the present invention and the filtration filter using such microporous membrane can efficiently capture particles for a long period of time, and are excellent in heat resistance and chemical resistance, and thus can be used in the various situations where filtration is required. The crystalline polymer microporous membrane and the filtration filter can be suitably used for precise filtration of gas, fluid, or the like. For example, the crystalline polymer microporous membrane and the filtration filter can be widely used for filtration of various gases, filtration, sterilization, and high temperature filtration of washing water for electronic industry, medical water, water used in pharmaceutical production processes, water for use in the food industry, and filtration of reactive chemicals. Furthermore, the crystalline polymer microporous membrane and the filtration filter can also used as a wire coating material.

What is claimed is:

1. A method for producing a crystalline polymer microporous membrane, comprising:
placing a first crystalline polymer in a metal mold, and compressing the first crystalline polymer to form a first preforming body;
placing a second crystalline polymer in a metal mold, and compressing the second crystalline polymer to form a second preforming body;
extruding each of the first preforming body and the second preforming body to form a first extrusion body and a second extrusion body, respectively;
laminating the first extrusion body and the second extrusion body to form a laminate;
rolling the laminate;
heating a surface of the laminate to perform asymmetric heating to thereby give a temperature gradient in a thickness direction of the laminate; and
drawing the laminate,
wherein the crystalline polymer microporous membrane contains a laminate of two or more layers, in which a layer containing the first crystalline polymer and a layer containing the second crystalline polymer are laminated, and a plurality of pores each piercing through the laminate in a thickness direction thereof,
wherein the first crystalline polymer has higher crystallinity than crystallinity of the second crystalline polymer, and the layer containing the first crystalline polymer has the maximum thickness thicker than the maximum thickness of the layer containing the second crystalline polymer, and
wherein at least one layer in the laminate has a plurality of pores whose average diameter continuously or discontinuously changes along with a thickness direction thereof at least at part of the layer.

2. The method according to claim 1, wherein the compressing is performed at a pressure of 0.01 MPa to 100 MPa.

3. The method according to claim 1, wherein the compressing is performed by applying a pressure for 0.01 seconds to 1,000 seconds.

4. The method according to claim 1, wherein the compressing contains heating at 5° C. to 35° C.

5. The method according to claim 1, wherein the extruding is performed at a temperature of 15° C. to 200° C.

6. The method according to claim 1, wherein the extruding is performed at a pressure of 0.001 MPa to 1,000 MPa.

7. The method according to claim 1, wherein the rolling is performed at a temperature of 19° C. to 380° C.

8. The method according to claim 1, wherein the rolling is performed at a pressure of 0.001 MPa to 1,000 MPa.

9. The method according to claim 1, wherein the asymmetric heating is performed at a temperature of 322° C. to 361° C.

10. The method according to claim 1, wherein the laminate has a draw ratio of 1.2 times to 50 times with respect to a length direction of the laminate.

11. The method according to claim 1, wherein the laminate has a draw ratio of 1.2 times to 50 times with respect to a width direction of the laminate.

12. The method according to claim 1, wherein the first extrusion body has a thickness thicker than that of the second extrusion body.

13. The method according to claim 1, wherein the first crystalline polymer has the crystallinity 1.02 or more times the crystallinity of the second crystalline polymer.

14. The method according to claim 1, wherein the first crystalline polymer is polytetrafluoroethylene.

15. The method according to claim 1, wherein the second crystalline polymer is polytetrafluoroethylene, or a polytetrafluoroethylene copolymer.

16. A crystalline polymer microporous membrane, comprising:
a laminate of two or more layers, including a layer containing a first crystalline polymer and a layer containing a second crystalline polymer, and the laminate containing a plurality of pores each piercing through the laminate in a thickness direction thereof,
wherein the first crystalline polymer has higher crystallinity than crystallinity of the second crystalline polymer, and the layer containing the first crystalline polymer has the maximum thickness thicker than the maximum thickness of the layer containing the second crystalline polymer,
wherein at least one layer in the laminate has a plurality of pores whose average diameter continuously or discontinuously changes along with a thickness direction thereof at least at part of the layer, and
wherein the crystalline polymer microporous membrane is obtained by the method containing:
placing the first crystalline polymer in a metal mold, and compressing the first crystalline polymer to form a first preforming body;
placing the second crystalline polymer in a metal mold, and compressing the second crystalline polymer to form a second preforming body;
extruding each of the first preforming body and the second preforming body to form a first extrusion body and a second extrusion body, respectively;
laminating the first extrusion body and the second extrusion body to form a laminate;
rolling the laminate;
heating a surface of the laminate to perform asymmetric heating to thereby give a temperature gradient in a thickness direction of the laminate; and
drawing the laminate.

17. A filtration filter, comprising:
a crystalline polymer microporous membrane obtained by the method containing:
placing a first crystalline polymer in a metal mold, and compressing the first crystalline polymer to form a first preforming body;
placing a second crystalline polymer in a metal mold, and compressing the second crystalline polymer to form a second preforming body;
extruding each of the first preforming body and the second preforming body to form a first extrusion body and a second extrusion body, respectively;
laminating the first extrusion body and the second extrusion body to form a laminate;
rolling the laminate;
heating a surface of the laminate to perform asymmetric heating to thereby give a temperature gradient in a thickness direction of the laminate; and
drawing the laminate,
wherein the crystalline polymer microporous membrane contains a laminate of two or more layers, in which a layer containing the first crystalline polymer and a layer containing the second crystalline polymer are laminated, and a plurality of pores each piercing through the laminate in a thickness direction thereof,
wherein the first crystalline polymer has higher crystallinity than crystallinity of the second crystalline polymer, and the layer containing the first crystalline polymer has the maximum thickness thicker than the maximum thickness of the layer containing the second crystalline polymer, and
wherein at least one layer in the laminate has a plurality of pores whose average diameter continuously or discontinuously changes along with a thickness direction thereof at least at part of the layer.

18. The filtration filter according to claim 17, wherein a surface of the crystalline polymer microporous membrane having an average pore diameter larger than the other surface thereof is arranged as a filtering surface of the filtration filter.
